(19) United States
(12) Patent Application Publication
(10) Pub. No.: US 2025/0083839 A1
(43) Pub. Date: Mar. 13, 2025

(54) Robot Operable to Fly and Hop

(71) Applicant: City University of Hong Kong, Kowloon (HK)

(72) Inventors: Songnan Bai, Kowloon (HK); Pakpong Chirarattananon, Kowloon (HK); Runze Ding, Kowloon (HK)

(21) Appl. No.: 18/465,403

(22) Filed: Sep. 12, 2023

(51) Int. Cl. B64U 10/14; B64U 10/80; B64U 20/70

(52) U.S. Cl. CPC B64U 10/14; B64U 60/55; B64C 2025/008; B64U 2201/10

(57) ABSTRACT

There is provided a robot comprising an aerial unit, a passive leg mechanism operably coupled with the aerial unit, and a controller. The controller is configured to control operation of the aerial unit such that the robot is operable in, at least, a flight mode and a hopping mode.

### TECHNICAL FIELD

The present invention relates to a robot operable to fly and hop (e.g., a hybrid hopping and flying robot) and its control method.

### BACKGROUND

Many organisms in nature achieve hybrid locomotion through the integration of jumping and flying behaviors. Arboreal foraging birds such as parrotlets and sparrows exhibit high agility by combining jumps between branches with intermittent flights (1). Insects such as locusts, froghoppers, and fleas integrate jumping and flying behaviors to navigate complex environments and evade predators (2-4). Flying squirrels (5) and Draco lizards (6) perform hybrid jumping and gliding to achieve long jump distances. These examples demonstrate the potential benefits of hybrid jumping-flying locomotion for improving mobility, agility, efficiency and versatility.

Developing a hybrid hopping-flying robot that can achieve continuous jumping and flying is challenging, particularly when considering the limitations and complexity of conventional jumping mechanisms. While a few combustion-driven robotic jumpers have been reported (7-10), existing robots capable of jumping are primarily based on either latched (11-29) or unlatched (30-36) actuation mechanisms.

Jumpers with latched actuation mechanisms employ a catch mechanism to enable rapid energy release from mounted elastomer, making varying jump height and continuous hopping difficult. If the explosive energy release is passively triggered (via cam escapement or pawl-and-ratchet mechanisms, for instance) (11-15, 19, 22-24, 26-29), the jump height is fixed according to the pre-determined tension, thereby limiting the robot's capability. On the other hand, if the explosive energy release is actively triggered, the jump height is variable but continuous hopping remains difficult as the release must be precisely timed when the robot lands (17,18,20,25), thereby impacting the robot's jumping agility.

Jumpers with unlatched actuation mechanisms can directly drive their legs with actuators (30, 37-39), enabling continuous hopping with variable height. However, without energy storage, they cannot generate sufficient instantaneous power for high jumps. To address this limitation, elastomers are used in parallel (34, 36) or series-elastic (31-33) jumping mechanisms are used to temporarily store the energy produced by the actuator and amplify the output power during the stance phase. With carefully designed linkages and nonlinear spring stiffness, these robots may benefit from variable mechanical advantage, demonstrating agile continuous hopping with superior vertical jumping agility (21, 31-33). However, they necessitate a relatively complex mechanical structure, higher actuator power, and non-negligible stance time. These somewhat restrict hopping agility as the robot must spend a certain amount of time in stance for the actuator to inject.

Existing attempts to create robots capable of both jumping and flight have directly combined jumping mechanisms with aerial platforms (15-18, 40-42). This allows the robots to rapidly gain altitude through jumping-assisted takeoff. However, these existing robots cannot achieve continuous hopping, fine-tune jump height, and/or sustained flight.

### SUMMARY OF THE INVENTION

In some embodiments of the invention, there is provided a hybrid hopping-flying robot that augments a micro aerial vehicle with a passive elastic telescopic leg (FIG. 1). This results in a mechanically simple and efficient design that directly leverages the existing rotors of the micro aerial vehicle for jumping. A robot that can jump and fly is known (43), but it could only execute isolated jumps between flights and cannot perform continuous hopping. Unlike this existing robot, the hybrid hopping and flying robot in some embodiments of the invention is actuated in the aerial phase rather than in the stance phase, thus enabling continuous hopping and adjustable jump height.

The passive elastic leg differentiates the hybrid hopping and flying robot in some embodiments of the invention (i.e., referred to as “Hopcopter” herein) from existing jumping robots, allowing it to achieve unprecedented hopping agility. The absence of stance actuation permits a shorter stance phase, enabling higher jumping frequencies and agility. To demonstrate high hopping agility, a 42-gram Hopcopter prototype is constructed, and the robot's hopping dynamics are identified and characterized. Based on the results, a model-based hopping controller is developed to stabilize the robot during hopping using external feedback. For each hop, the passive telescopic leg absorbs and stores kinetic energy through elastic recoil, while the thrust-based actuation compensates for energy loss and stabilizes attitude and velocity. Experimental results show that the robot can accurately track a reference trajectory, validating the proposed three-dimensional hopping model and showing that the Hopcopter's average hopping speeds approach the theoretical ballistic limit, surpassing state-of-the-art jumping robots including Salto-1P (32). This distinguishes the proposed approach from those relying on latched elastic actuation, which imposes limitations on continuous hopping and variable jump heights, and from those relying on unlatched series elastic actuation, which require a longer stance time. In flight mode, the robot in some embodiments of the invention functions as a regular micro aerial vehicle, allowing for stable hovering, agile maneuvering, and smooth flight-hopping transitions. Intermittent hops during flight dramatically enhance instantaneous accelerations for rapid and tight turns.

To attain stable hopping using onboard sensors only, the robot is outfitted with active aerodynamic stabilizers. These surfaces dynamically influence landing attitude, stabilizing hopping speed and attitude without external feedback or vision. The realized hybrid hopping-flying locomotion of Hopcopter offers unprecedented versatility in navigating complex environments. Unlike wheeled aerial vehicles that struggle to negotiate rough terrains (44-50), the hopping ability allows the robot to overcome obstacles and traverse uneven surfaces. Compared to flight-capable bipedal and legged robots (51-54), the hopping mechanism is far more efficient, requiring less energy for locomotion. By seamlessly integrating flying and jumping, our approach enables synergistic hybrid locomotion, with the flight mechanism facilitating passive jumping and intermittent jumping generating large accelerations for rapid turns when flying. This multimodal locomotion capability has the potential to radically expand the range of environments in which robots can operate effectively and efficiently, from cluttered indoor spaces to rugged outdoor terrains.

According to an aspect of the invention, there is provided a robot which includes an aerial unit, a passive leg mechanism operably coupled with the aerial unit, and a controller configured to control operation of the aerial unit such that the robot is operable in, at least, a flight mode and a hopping mode.

In some embodiments, the controller may be configured to control operation of the aerial unit such that the robot alternates between the flight mode and the hopping mode during operation.

In some embodiments, the passive leg mechanism may consist only of a single telescopic leg arrangement.

In some embodiments, the single telescopic leg arrangement may include an upper leg section fixed to the aerial unit, a lower leg section movably connected with the upper leg section via one or more connectors, and an elastic mechanism operably coupled between the upper leg section and the lower leg section.

In some embodiments, the controller may be configured to predict a landing location of the robot in the hopping mode.

In some embodiments, the controller may be configured to determine a landing location of the robot for a next hopping cycle based on a landing attitude of the robot for a current hopping cycle.

In some embodiments, the aerial unit may include a mini unmanned aerial vehicle or a micro unmanned aerial vehicle.

In some embodiments, the aerial unit may include a micro quadcopter.

In some embodiments, the telescopic leg arrangement may further include one or more guide wheel sets, each of the one or more guide wheel sets being operably coupled between a respective one of the one or more connectors and the lower leg section to restrict motion of the lower leg section to translation only and to reduce the friction. The guide wheel sets may include, e.g., bearings.

In some embodiments, the lower leg section may include a foot for contacting ground or environment.

In some embodiments, the lower leg section may include a first hook for supporting part of the elastic mechanism, and at least one of the connectors may include a second hook for supporting another part of the elastic mechanism.

In some embodiments, the elastic mechanism may include one or more elastic elements.

In some embodiments, the one or more elastic elements may be mounted between the upper leg section and the lower leg section such that the one or more elastic elements are tensioned to provide an elastic force operable to overpower weight of the robot.

In some embodiments, a length measured from a lowest end of the lower leg section to a center of mass (CoM) of the robot is at least twice the length of a wheelbase of the aerial unit.

In some embodiments, the robot may further include a stabilizer operable to interact with airflow to stabilize the robot.

In some embodiments, the stabilizer may be configured to control a landing attitude and to stabilize hopping speed and attitude without external feedback or vision.

In some embodiments, the stabilizer may include one or more horizontally hinged surfaces.

In some embodiments, the one or more horizontally hinged surfaces may be actuated by a cable arrangement connected to a drive unit.

In some embodiments, the one or more horizontally hinged surfaces may be arranged to be made rigid when the cable arrangement is actuated and swing freely in response to airflow when the cable arrangement is de-actuated.

In some embodiments, the controller may be configured to predict a landing location and velocity of the robot for a current hopping cycle (k), determine a takeoff attitude and a takeoff velocity of the robot for the current hopping cycle (k) based on: the predicted landing location and velocity, a pre-specified landing location, and a hopping altitude setpoint for a next hopping cycle (k+1), determine a desired landing attitude for the current hopping cycle (k) to realize the determined takeoff attitude and takeoff velocity of the robot for the current hopping cycle (k), and control a landing location for the next hopping cycle (k+1) and stabilize the robot by regulating the landing attitude of the current hopping cycle (k).

In some embodiments, the controller may be configured to determine the landing location for the next hopping cycle (k+1) based on a lateral component of the takeoff velocity and an amount of time the robot spends in an aerial phase, and the takeoff velocity is influenced by the landing attitude.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings, in which:

FIG. 1A shows a hybrid hopping and flying robot according to an embodiment of the invention.

FIG. 1B is an enlarged diagram of part A of the hybrid hopping and flying robot of FIG. 1A, illustrating a retractable leg mechanism.

FIG. 2A is a schematic diagram illustrating dynamics of the hybrid hopping and flying robot and two phases of a complete jumping cycle.

FIG. 2B is an illustration of stance phase dynamics from landing (t_{LD}) to takeoff (t_{TO}).

FIG. 2C shows takeoff state prediction using the identified stance phase dynamics.

FIG. 3A is a schematic diagram illustrating an example hopping trajectory in different phases from control perspective.

FIG. 3B is a block diagram showing hierarchical structure of a controller according to an embodiment of the invention.

FIG. 4 shows trajectory tracking experiments under a hopping mode: FIG. 4, in A, shows reference and realized circular trajectories; FIG. 4, in B, shows reference and realized step trajectories; and FIG. 4, in C, shows a diagram showing the robot tracking step trajectory.

FIG. 5A is a graph showing hopping period against hopping height, predicted according to a model according to an embodiment of the invention.

FIG. 5B is a graph showing hopping agilities against hopping height of the robot according to an embodiment of the invention and existing jumping robots.

FIG. 6A and FIG. 6B show demonstration of hybrid jumping and flying locomotion of a hybrid hopping and flying robot according to an embodiment of the invention to show the robot utilizing the ground to decelerate from lateral translation.

FIG. 6C and FIG. 6D show a composite image and time course of position of a hybrid hopping and flying robot according to an embodiment of the invention to show the robot utilizing the ground to perform a 90° tight turn.

FIG. 6E and FIG. 6F show two sequential composite images and data to show the robot utilizing a wall and a tilted plane to reverse it flight direction (U-turn) and brake.

FIG. 7A shows a hybrid hopping and flying robot including a detachable active aerodynamic stabilizer according to an embodiment of the invention.

FIG. 7B is an enlarged diagram of part C of the hybrid hopping and flying robot of FIG. 7A, illustrating the stabilizer according to an embodiment of the invention.

FIG. 7C is a diagram displaying relationships between landing velocity, landing attitude and takeoff velocity.

FIG. 7D shows Poincaré maps depicting the evolution of landing velocity angle θ_{z} in terms of θ_{z}|ₖ₊₁/θ_{z}|ₖ, as a function of θ_{z}|ₖ and ϕ|ₖ.

FIG. 8A is a schematic diagram of an example setup of drop tests of the robot for parameter identification.

FIG. 8B is an example diagram of the robot from a high speed video and the tracked features.

FIG. 8C shows altitude of the robot in the free-drop experiments where dark and light curves represent falling and ascending (downstroke and upstroke) phases.

FIG. 8D shows vertical acceleration versus compressed length of the robot in the stance phase after the drops.

FIG. 9 shows an example trajectory of the leg contraction l(t) of the robot where the solid dark and light lines represent the analytical solutions of l(t) during the downstroke and upstroke, respectively, and the dashed lines represent the extended solutions.

FIG. 10 shows a trajectory of hybrid locomotion of the robot with longitudinal acceleration and deceleration.

FIG. 11 shows a trajectory of hybrid locomotion of the robot with a 90° turn.

FIG. 12 shows a trajectory of hybrid locomotion with a U-turn.

FIG. 13 shows a trajectory of hybrid locomotion with non-horizontal surfaces.

FIG. 14 shows Poincaré maps depicting the evolution of the landing velocity angle θ_{z} in terms of θ_{z}|ₖ₊₁θ_{z}|ₖ, as a function of θ_{z}|ₖ and ϕ|ₖ: (A) shows predictions for the hopping height of 0.4 m; (B) shows predictions for the hopping height of 0.6 m; (C) shows predictions for the hopping height of 0.7 m; and (D) shows predictions for the hopping height of 0.8 m.

FIG. 15A and FIG. 15B show trajectory of the robot in passive stability test for three scenarios of stable hopping (achieved with both the aerodynamic stabilizer and attitude controller), hopping with the attitude controller only, and hopping with the aerodynamics stabilizer only.

FIG. 16 shows altitude of the robot in agility evaluation.

FIG. 17 shows results from endurance test: (A) shows the altitude of the robot while hopping and the respective motor commands; and (B) shows onboard battery voltage of the robots when jumping and flying.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

The invention generally relates to a robot that includes an aerial unit, a passive leg mechanism operably coupled with the aerial unit, and a controller configured to control operation of the aerial unit such that the robot is operable in, at least, a flight mode and a hopping mode. The following disclosure provides some example embodiments of the robot of the invention.

### Hopcopter Platform in Some Embodiments

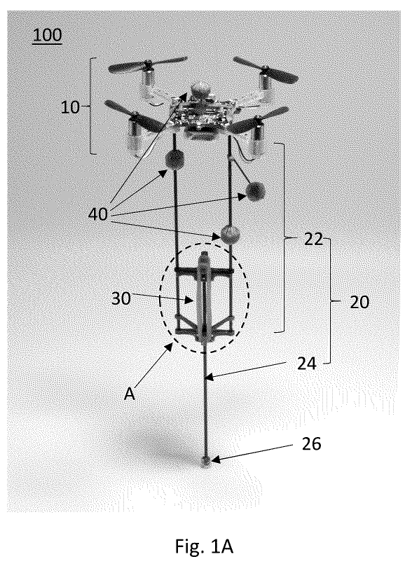

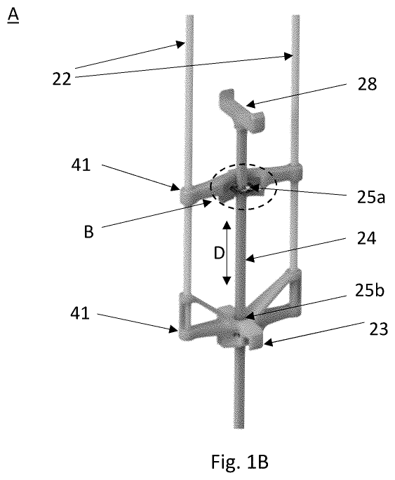

A hybrid hopping and flying robot (or vehicle) according to an embodiment is provided. The hybrid hopping and flying robot is referred to as “Hopcopter” herein. As shown in FIG. 1A, the hybrid hopping and flying robot 100 includes an aerial unit 10 and a passive leg mechanism 20 operably coupled with the aerial unit 10. The aerial unit 10 may include a mini unmanned aerial vehicle or a micro unmanned aerial vehicle. The aerial unit 10 may include a micro quadcopter (for example, Bitcraze, Crazyflie 2.1, 27 grams). The passive leg mechanism 20 can include a telescopic leg mechanism or a retractable leg mechanism. The passive leg mechanism 20 features a rigidly fixed upper leg section 22 on the aerial unit 10, a sliding rod as a lower leg section 24, and elastic elements (for example, rubber bands) acting as an elastic mechanism 30. The upper leg section 22 may be made of two carbon fiber rods (for example, diameter: 1.8 mm) rigidly mounted below the aerial unit 10 via, for example, fasteners. The fasteners may include 3D printed fasteners (for example, Formlab Form 3, Tough 2000). FIG. 1B is an enlarged diagram showing part A in FIG. 1A. As shown in FIG. 1A and FIG. 1B, the lower leg section 24 includes a single rod, a pointy foot 26, and a hook 28 for mounting the rubber bands (for example, a 3D printed hook), which can constitute the main moving components of the hopping mechanism. The lower leg section 24 may be made of a single carbon-fiber rod (for example, 2×2 mm²-square cross section). The lower leg section 24 is movably connected with the upper leg section 22 by one or more connectors 41. The passive leg mechanism 20 further includes one or more guide wheel sets 25a and 25b between the connectors 41 and the lower leg section 24 to restrict motion to vertical translation. That is, each of the one or more guide wheel sets is operably coupled between a respective one of the one or more connectors 41 and the lower leg section 24 to restrict motion of the lower leg section 24 to translation only. Part B in FIG. 1B provides a partial sectional view to show the guide wheel set 25a arranged between the connector 41 and the lower leg section 24. In particular, the lower leg section 24 connects to the upper leg section 22 via two sets of guide wheel sets 25a and 25b, restricting motion to vertical translation (moving direction D) and minimizing sliding friction. The guide wheel sets 25a and 25b may include, e.g., bearings. In this configuration, the axis of translation passes through the center of mass (CoM) of the robot 100. Two rubber bands 30 (for example, diameter: ≈1.5 mm and ring radius: ≈20 mm) anchor between the upper leg section 22 and the tip of the lower leg section 24 as the elastic element. The bands 30 are mounted such that they are pre-stretched and further elongated upon the leg contraction. In addition, one or more reflective spherical markers 40 are affixed on the robot 100 to obtain the pose measurements from a motion capture system. For example, the one or more reflective spherical markers 40 may include four reflective spherical markers. In an embodiment, the entire Hopcopter weighs 34.8 grams, lower than the maximum takeoff weight of 42 g.

The design incorporates two key features to simplify the stance phase dynamics. Firstly, the passive leg mechanism 20 (i.e., the telescopic leg), at 22 cm long (from the foot to the CoM of the robot), is over twice the length of the quadcopter 10's 9 cm wheelbase. Secondly, the rubber bands 30 are pre-stretched, enabling the elastic force to overpower the robot 100's weight. These features allow the robot 100 to be treated as a point mass during the stance phase and decouple the dynamics from gravity's orientation as detailed in the subsequent section.

### Aerial and Stance Dynamics

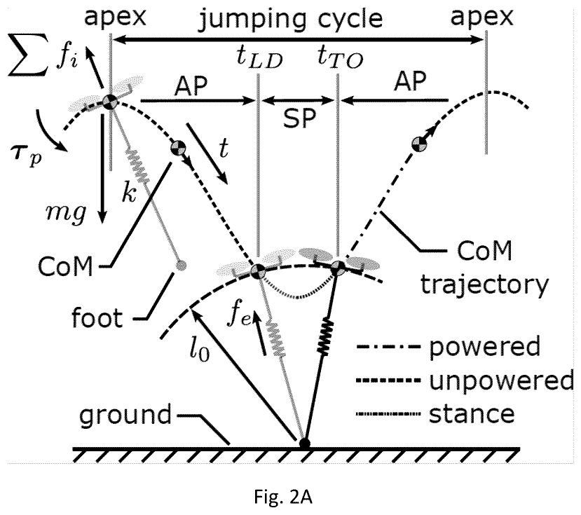

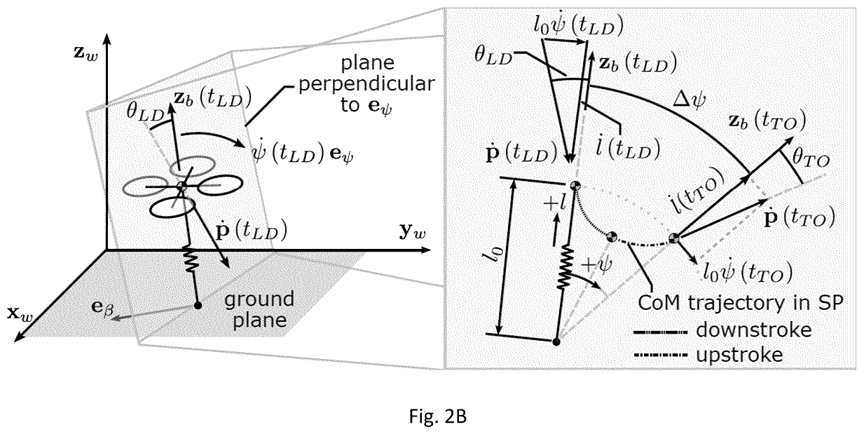

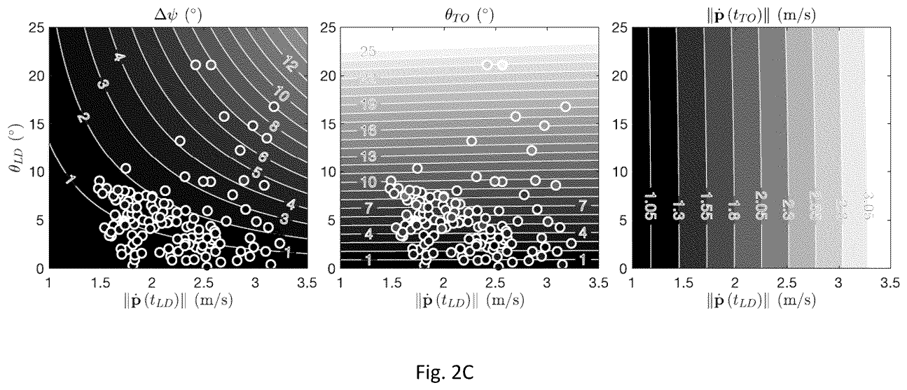

In flight, Hopcopter's dynamics are characterized by propelling torque (roll, pitch, and yaw) and collective thrust, indistinguishable from a regular rotorcraft (55-57). However, when functioning as a monopedal hopper, the robot is a hybrid dynamical system, with one jumping cycle alternating between the aerial and terrestrial stages, separated by the ground contact (58-60). For modeling purposes, in this work, the movement of the CoM of the hybrid robot in each jumping cycle is divided into two phases: aerial (AP), stance (SP) phases, separated by two key timestamps: landing (t_{LD}) and takeoff (t_{TO}) as illustrated in FIG. 2A.

Without the ground contact, in the AP, the robot shares the same flight dynamics with a regular quadcopter with six degrees of freedom (DoFs) in the form of rotational and translational motion. Upon landing, under the condition of no slippage between the foot and the ground (58, 59), the attitude and position of the robot are physically coupled. The ground contact acts as a pivot for the body attitude, with the distance to the CoM changing with the leg contraction. The foot collision marks the transition between AP and SP. A comprehensive model consists of two sets of dynamics and the state transitions between them. Inspired by the classical spring-loaded inverted pendulum (SLIP) model (59, 61), the embodiments of the invention propose a simplified yet complete three-dimensional jumping model that captures the dominant effects, suitable for real-time jumping control.

### Aerial Phase

When flying, the robot is modeled as a rigid body with weight mg and inertia tensor I=diag (Iₓ, I_{y}, I_{z}) in a gravity field. The lightweight telescopic leg is abstracted as a thin rod with a preloaded elastomer. The leg axis passes through the CoM of the robot and aligns with the thrust direction of the propellers as schematically illustrated in FIGS. 2A and 2B. FIG. 2A is a schematic diagram illustrating the dynamics and the two phases of a complete jumping cycle. FIG. 2B is an illustration of the stance phase dynamics from landing (t_{LD}) to takeoff (t_{TO}). FIG. 2C shows takeoff state prediction using the identified stance phase dynamics where the 130 datapoints shows measured landing and takeoff state of the robot in an experiment of jumping model verification.

In the aerial phases, the equations of motion are identical to those of a regular multirotor vehicle (55-57, 62) and given by

$$m \ddot{p} = {z}_{b} \sum {f}_{i} - {e}_{3} m g , \qquad ( 1 )$$

$${τ}_{p} = I \dot{ω} + ω \times I ω , \qquad ( 2 )$$

where p=[x,y,z]^{T} denotes the position vector of the CoM of the robot in the inertial frame {x_{w},y_{w},z_{w}}. The z axis of the body-fixed frame {x_{b},y_{b},z_{b}}, as seen in the inertial frame, represents the thrust direction of the propellers: z_{b}=Re₃, where R∈SO (3) is a rotation matrix mapping the body-fixed frame to the inertial frame and e₃=[0,0,1]^{T} is a basis vector. ω=[ωₓ,ω_{y},ω_{z}]^{T} is the body-centric angular velocity. The summation Σfᵢ denotes the total thrust magnitude and τₚ is the total propelling torque in the body frame. Together Σfᵢ and τₚ are control inputs that can be commanded via distributing the power between the four rotors. In a regular flight regime, aerodynamic drag can be neglected (56, 62).

### Landing Transition

Once landed (timestamp t_{LD} in FIG. 2A), the ground normal brings about the leg contraction, decreasing the leg length l(t) from the nominal state of, for example, l₀=22 cm. Without any influence from the propelling thrust, the SP dynamics is completely passive. The main robot body interacts with the ground through the telescopic leg in the form of the restoring force created by the elastomer fₑ. Since the robot can be treated as a point mass (32, 58, 59) instead of a rigid body (Iₓ, I_{y}, I_{z} «ml₀², thanks to the long leg length as discussed in Note S1 in Supplementary Note section provided in the end part of the description), the robot follows the equation of motion

$$m \ddot{p} = - {e}_{3} m g + {z}_{b} {f}_{e} . \qquad ( 3 )$$

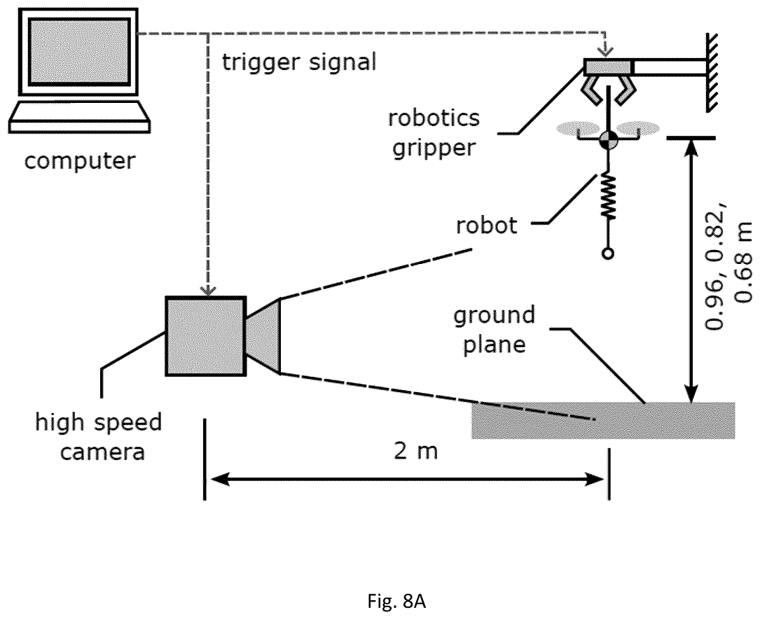

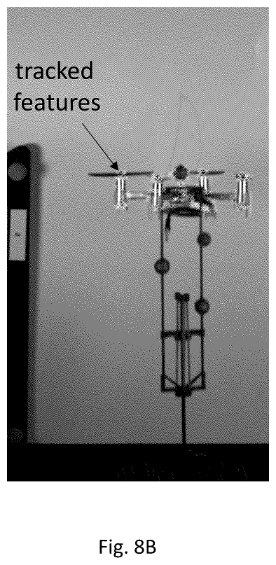

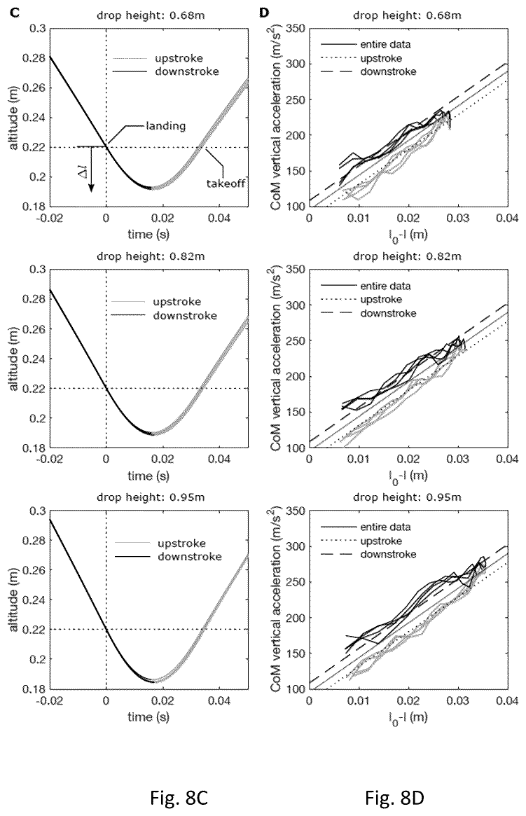

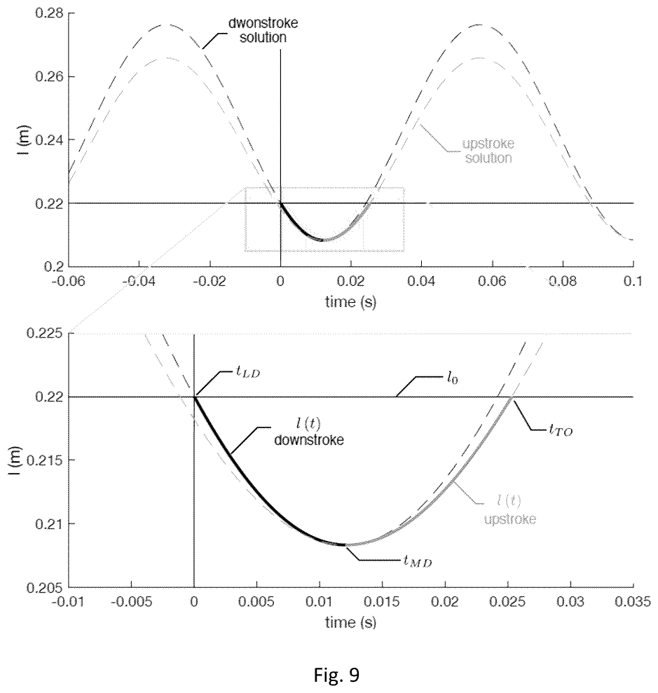

Based on the measurements from the drop tests (see Materials and Methods section and FIG. 8A to FIG. 8D), the elastic force fₑ is linearly proportional to the deformation of the elastomer l−l₀−lₚ by a constant k, with a constant friction (likely attributed to the bearing or the elastic hysteresis) of magnitude f_{c}

$${f}_{e} = - k ( l - {l}_{0} - {l}_{p} ) - sgn ( \dot{l} ) {f}_{c} for l < {l}_{0} , \qquad ( 4 )$$

where l−l₀ is the leg contraction and lₚ is the pre-stretched length of the elastomer. The friction term accounts for the dissipating energy that results in a hysteresis behavior brought by the loading/downstroke (\dot{l}<0) and unloading/upstroke (\dot{l}>0) motion (see FIG. 8D). By design, the preload force klₚ prevails the weight of the robot (klₚ=3.35 N versus mg=0.34 N, see Materials and Methods section and Table S1). Therefore, the stance dynamics is nominated by fₑ and Equation 3 simplifies to

$$m \ddot{p} = {z}_{b} {f}_{e} , \qquad ( 5 )$$

Assuming no slippage (thanks to the pointy foot), the ground contact point can be regarded as a free-to-rotate spherical hinge and the CoM of the robot is restricted to the translation along the leg axis and the rotation about the foot as shown in FIGS. 2A and 2B. Since the elastic force fₑ is always along the axial direction, the angular momentum measured with respect to the ground contact in the SP is conserved, the trajectory of the CoM can be separately described as the axial and angular motion and is independent of the gravity direction. Denoting the landing velocity as \dot{p}(t_{LD}) and θ_{LD}∈[0, π) as the angle between \dot{p}(t_{LD}) and the leg axis z_{b}(t_{LD}), we yield the leg contraction speed at touchdown \dot{l}(t_{LD}) z_{b}(t_{LD})·\dot{p}(t_{LD})+−∥\dot{p}(t_{LD})∥cos θ_{LD}. As long as the body-centric angular velocity immediately before landing is minimized, the angular speed of the CoM \dot{ψ}(t_{LD}) with respect to the ground is the component of \dot{p}(t_{LD}) in the direction orthogonal to z_{b} or l₀\dot{ψ}(t_{LD})=∥\dot{p}(t_{LD})×z_{b}(t_{LD})∥=∥\dot{p}(t_{LD})∥sin θ_{LD}. As illustrated in FIG. 2B, the subsequent angular motion is characterized by the rotational axis defined by e_{ψ}=−\dot{p}(t_{LD})×z_{b}(t_{LD})/∥\dot{p}(t_{LD})∥, perpendicular to both \dot{p}(t_{LD}) and z_{b}(t_{LD}). The axial \dot{l}(t_{LD}) and angular \dot{ψ}(t_{LD}) speeds become the initial conditions of the robot in the SP.

### Stance Phase and Takeoff Transition

Unlike existing studies of the three-dimensional SLIP models (58, 63), the complexity of the stance dynamics of the Hopcopter is further reduced owing to the strategic design decision to substantially pre-stretch the elastomer. As detailed in Note S2, when the directions of \dot{p}(t_{LD}) and z_{b}(t_{LD}) are largely aligned, the centrifugal acceleration is negligible and the SP is governed by the axial and angular dynamics in the form of two semi-coupled differential equations:

$$m \frac{d}{dt} \dot{l} = - k ( l - {l}_{0} - {l}_{p} ) - sgn ( \dot{l} ) {f}_{c} , \qquad ( 6 )$$

$$m \frac{d}{dt} ( {l}^{2} \dot{ψ} ) = 0. \qquad ( 7 )$$

Given the initial conditions (∥\dot{p}(t_{LD})∥ and θ_{LD}), the axial dynamics is independent of ψ and dictated by the natural frequency Ω=k/m. We yield an analytical solution of l(t) and the takeoff timestamp t_{TO} corresponding to the moment when the elastic force vanishes (l(t_{TO})=l₀) as detailed in Note S3. With the expression of l(t), Equation (7) states that \dot{ψ}(t)=l₀²\dot{ψ}(t_{LD})/l²(t). The time integration Δψ=∫ₜ_{_{LD}}^{t}^{_{TO}}\dot{ψ}(t)dt provides the attitude of the robot at the takeoff as the rotation of z_{b}(t) about the axis e_{ψ} in stance phase (t_{SP}, from t_{LD} to t_{TO}, see FIG. 2B). Therefore, the change in the body attitude z_{b}(t), in terms of Δψ, in the entire SP is also fully determined from ∥\dot{p}(t_{LD})∥ and θ_{LD}. Reprojecting to the inertial frame, the takeoff attitude of the robot is given by

$$R ( {t}_{TO} ) = R ( {e}_{ψ} , Δψ ) R ( {t}_{L D} ) , \qquad ( 8 )$$

where R(e_{ψ}, Δψ) is a rotation matrix based on the axis-angle representation. Letting z_{b}(t_{TO})=R(t_{TO})e₃ be the primary body axis at t_{TO}, the takeoff velocity \dot{p}(t_{TO}) is obtained by projecting the axial \dot{l}(t_{TO}) and tangential speeds l₀\dot{ψ}(t_{TO}) of the robot at t_{TO} to the inertial frame. This results in ∥\dot{p}(t_{TO})∥=\sqrt{l₀²\dot{ψ}²(t_{TO})+\dot{l}²(t_{TO})} with the direction specified by the angle between z_{b}(t_{TO}) and \dot{p}(t_{TO}), θ_{TO}=arctan (l₀\dot{ψ}(t_{TO})/(t_{TO})). In the vector form, this is given by

$$\dot{p} ( {t}_{T O} ) = \dot{l} ( {t}_{T O} ) {z}_{b} ( {t}_{T O} ) + {l}_{0} \dot{ψ} ( {t}_{T O} ) {e}_{ψ} \times {z}_{b} ( {t}_{T O} ) . \qquad ( 9 )$$

$$= ‖ \dot{p} ( {t}_{L D} ) ‖ R ( {e}_{ψ} , {θ}_{T O} ) {z}_{b} ( {t}_{T O} ) , \qquad ( 10 )$$

As illustrated in FIG. 2B, due to the conservative of angler momentum, vectors z_{b}(t_{LD}), \dot{p}(t_{LD}), z_{b}(t_{TO}) and \dot{p}(t_{TO}) are all coplanar and perpendicular to e_{ψ} and the takeoff velocity is directly influenced by the landing attitude. Therefore, the jumping trajectory can be controlled through the manipulation of z_{b}(t_{LD}).

With the identified model coefficients (Ω=k/m, f_{c}/m, and lₚ in Table S1) from the drop tests (see Materials and Methods section), the takeoff state of the robot specified by Δψ, θ_{TO} and ∥\dot{p}(t_{TO})∥ is predicted according to the landing state (θ_{LD} and ∥\dot{p}(t_{LD})∥) in FIG. 2C. The maps suggest that, for a given landing velocity \dot{p}(t_{LD}), the liftoff velocity \dot{p}(t_{TO}) can be directly manipulated through θ_{LD} in the form of the landing attitude z_{b}(t_{LD}). This forms the basis of the model-based hopping controller.

### Model-Based Hopping Controller

Similar to other spring-mass monopeds, the passive jumping dynamics of the Hopcopter is unstable and lossy. Stabilizing the attitude of the robot in the aerial phase to guarantee an upright landing attitude is insufficient to prevent the horizontal speed from diverging after consecutive jumps (58, 63, 64). Concomitantly, energy must be injected into the system to compensate for losses in both stance and aerial phases. However, unlike monopedal hoppers with direct leg actuation (e.g., linear hydraulic and hip actuators in (65) or a series-elastic actuator in (32)), the stance phase of the Hopcopter is completely passive. This unique hopping mechanism demands a dedicated control framework.

The proposed controller for the Hopcopter differs from widely employed policies (32-34, 64) based on Raibert's hopping machine (65) and other jumping controllers (34,36,38,58,63,66). The controller according to an embodiment allows the robot to take off in a desired direction in three dimensions. This capacity enables the robot to track trajectories while hopping and facilitates smooth transitions between aerial and terrestrial modes, enabling complex hybrid locomotion. For instance, during high-speed flight, the Hopcopter leverage the ground contact or environment to generate an instantaneous burst of acceleration and hop to decelerate, turn, or accelerate—significantly improving agility beyond flight alone.

The control strategy takes advantage of the derived model of the SP dynamics in order to (i) decrease the control effort and (ii) decouple the altitude control problem from the landing control problem as much as practically possible. As a result, the trajectory of the robot in the aerial phase is mostly ballistic and the landing position control is accomplished through the control of the landing attitude z_{b}(t_{LD}), in a similar manner to the control of the touchdown angle in (32). This differs from an existing jumping quadrotor (43), in which the position control is directly implemented during the aerial phase using a flight controller designed for a small rotorcraft. The framework renders the hopping locomotion markedly more efficient than flying. Besides, since the elastic force present in the SP dominates the propelling thrust, the use of the ground reaction force through the elastic leg for position control results in superior jumping agility.

### Overview of the Hopping Control Strategy

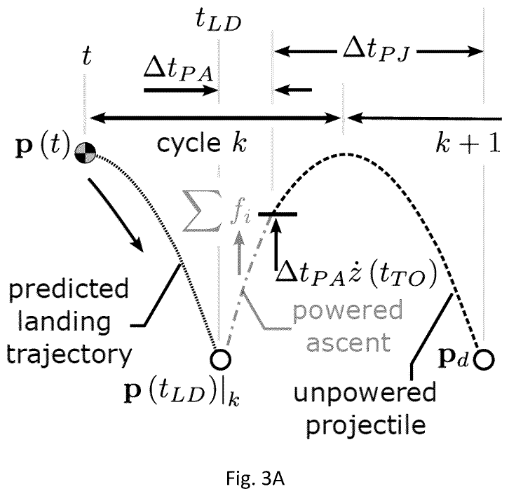

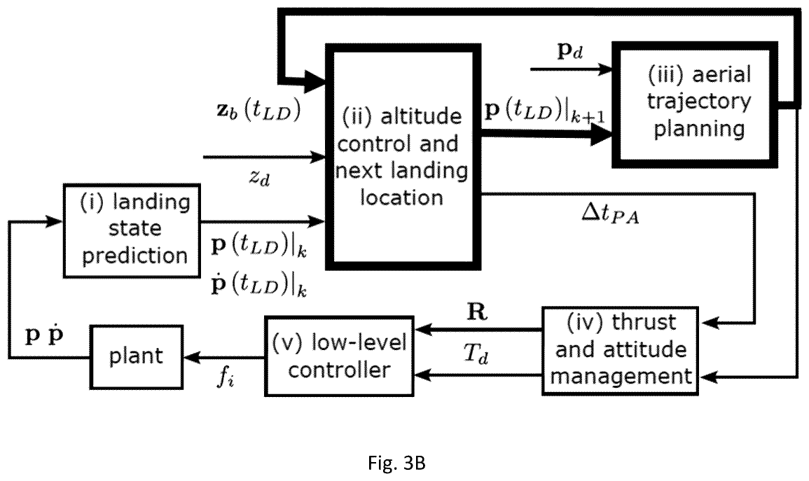

Since the hopping motion is cyclic and the aerial phase of the trajectory is primarily ballistic, the embodiments of the invention regulate the landing attitude of the current hopping cycle (indexed k) to yield the desired landing location in the subsequent hop (indexed k+1, as shown in FIG. 3A). The proposed method strategically decouples the attitude, altitude, and lateral dynamics of the robot by neglecting the aerodynamic drag and exploiting the ability of the robot to adeptly command its attitude in the aerial phase. The embodiments of the invention leverage the developed dynamic model to create a set of equations that predict the landing point at time step k+1 from the landing attitude at time step k and rely on these equations to numerically solve for the setpoint landing attitude that brings about the desired landing location at time step k+1. The structure of the controller may include five sub-modules, labeled (i) to (v), as outlined in FIG. 3B. Starting from the jumping cycle k, (i) predicts the landing location and velocity. This information, together with a pre-specified landing attitude and a hopping altitude setpoint, are employed to predict the takeoff state of cycle k in (ii). In (iii), a numerical optimizer relies on the output of (ii) to form an algebraic loop (bold in FIG. 3B) that determines the desired landing state of cycle k and the thrust requirement during the climb in cycle k to reach the hopping altitude setpoint and the next landing location in cycle k+1. Finally, (iv) is a thrust and attitude manager which converts the outcome from the solver in (iii) to command inputs for the low-level controller (v). The detailed implementations of the controller are as follows.

### Landing State Prediction

The high-level hopping controller loop is executed once per jump cycle. Starting from the apex of cycle k, the total thrust of the Hopcopter is nominally set to zero and the unpowered robot follows a ballistic trajectory as illustrated in FIG. 3A. From the current position p(t) and velocity \dot{p}(t) at timestamp t, the time to touchdown is determined from z=e₃^{T}p(t) and ż=e₃^{T}\dot{p}(t) as Δt_{LD}=t_{LD}−t=ż(t)/2+{square root over (2(z(t)−l₀)/g+ż²(t)/g²)}. The landing location and velocity are

$$p ( {t}_{L D} ) {\vert}_{k} = p ( t ) + \dot{p} ( t ) Δ {t}_{L D} - {e}_{3} \frac{1}{2} g Δ {t}_{L D}^{2} , \qquad ( 11 )$$

$$\dot{p} ( {t}_{L D} ) {\vert}_{k} = \dot{p} ( t ) - {e}_{3} g Δ {t}_{L D} . \qquad ( 12 )$$

During the descent, the attitude of the robot is controlled with the collective thrust and angular velocity minimized, allowing the motion to be treated as free fall from an altitude of z(t)−l₀.

### Altitude Control and Next Landing Location

Based on the landing setpoint attitude z_{b}(t_{LD})=R(t_{LD})e₃ and the computed landing velocity \dot{p}(t_{LD}), the stance phase dynamics (Equation 6 and Equation 7) is integrated forward to produce the liftoff state R(t_{TO}) and \dot{p}(t_{TO}) using Equation 8 and Equation 9 with θ(t_{LD})=arccos(−z(t_{LD})\dot{p}(t_{LD})/|\dot{p}(t_{LD})|). Immediately after taking off (detected by a significant change in the axial acceleration), the low-level controller (v) (described in Materials and Methods) swiftly re-orients the robot to an upright orientation (z_{b}−e₃) to minimize the horizontal thrust. Thus, the landing position of cycle k+1 is entirely determined by the lateral component of the liftoff velocity ([e₁,e₂]^{T}\dot{p}(t_{TO})|ₖ) and the time the robot spends in the aerial phase. This flight time is varied according to the setpoint altitude as the aerial maneuver is divided into a powered ascent (PA) and an unpowered projectile (PJ) (FIG. 3A). It is ensured that the hopping altitude setpoint z_{d} is reached by briefly producing vertical thrust of magnitude Σfᵢ=mg for

$$Δ {t}_{P A} = \{ \begin{matrix}( {z}_{d} ) / \dot{z} ( {t}_{T O} ) - \dot{z} ( {t}_{T O} ) / 2 g & for \dot{z} ( {t}_{T O} ) < 2 {gz}_{d} \\ 0 & otherwise ,\end{matrix} \qquad ( 13 )$$

where ż(t_{TO})=e₃^{T}\dot{p}(t_{TO}) is the vertical liftoff speed and z_{d} denotes the relative hopping altitude. The former case is when the vertical liftoff speed is insufficient for the robot to passively reach the setpoint and the latter is when the jump height without any thrust assistance is already over z_{d}. During the powered flight phase, the propelling thrust counterbalances the weight and the vehicle retains its upward speed of ż(t_{TO}). The rest of the trajectory is a projectile with duration of

$$Δ {t}_{P J} = \dot{z} ( {t}_{T O} ) / g + \sqrt{2 {z}_{d} / g} , \qquad ( 14 )$$

in which the first term refers to the rest of the time the robot spends ascending and the latter is free fall. Finally, the landing position for cycle k+1 is iteratively updated as

$$p ( {t}_{L D} ) {\vert}_{k + 1} = p ( {t}_{L D} ) {\vert}_{k} + {[ {e}_{1} {e}_{2} ]}^{T} \dot{p} ( {t}_{T O} ) {\vert}_{k} ( Δ {t}_{P A} + Δ {t}_{P J} ) . \qquad ( 15 )$$

The outcomes of Equations 11-15 verify that the touchdown location of the next cycle (k+1) is predominantly determined by the landing attitude z_{b}(t_{LD}) of the current cycle.

### Landing Attitude Computation and Aerial Trajectory Planning

From the estimated current landing position p(t_{LD}) k provided by Equation 11, the controller employs Equation 15 to iteratively search for the touchdown attitude that minimizes the predicted position error of the next landing,

$${z}_{b} ( {t}_{L D} ) {\vert}_{k} = arg {min}_{{z}_{b} ( {t}_{L D} ) {\vert}_{k}} ‖ {p}_{d} - p ( {t}_{L D} ) {\vert}_{k + 1} ‖ , \qquad ( 16 )$$

under the no-slip condition as constrained by the ground friction coefficient μ (Note S4)

$$arc cos ( {e}_{3} \cdot {z}_{b} ( {t}_{L D} ) ) {\vert}_{{}_{k}} , arc cos ( {e}_{3} \cdot {z}_{b} ( {t}_{T O} ) ) {\vert}_{{}_{k}} < {tan}^{- 1} μ . \qquad ( 17 )$$

Depending on the setpoint of p_{d} and the current state of the robot, the error \tilde{p} can be marginalized to zero or a particular value, which indicates whether the robot is able to reach the desired location in a single or multiple steps.

### Thrust and Attitude Manager

After the landing attitude z_{b}(t_{LD}) is determined from Equation 16, it is realized in when the robot is falling by the low-level controller (v). To regulate the jumping altitude, after the liftoff, the robot is quickly reoriented to an upright direction and the collective thrust magnitude is maintained at Σfᵢ=mg for Δt_{PA} as described by Equation 13. The action injects energy into the system to compensate for any losses. Thereafter, the robot remains upright until the landing location is again predicted by (i) for the next jump cycle.

### Planning Strategy for Trajectory Tracking

Unlike flying robots, which are able to stabilize any control errors continuously, the cyclic nature of the hopping motion only allows the corrective measure to be executed once per cycle. The action to alter the landing attitude when the robot is falling only affects the landing location in the next cycle. Therefore, to track a predefined trajectory, the desired landing location p_{d} in Equation 16 is chosen to be the desired location of the robot at t_{LD} k+₁, under the assumption that t_{LD}|ₖ₊₁−t=Δt_{LD}+2\sqrt{2z_{d}/g}. This consideration eliminates the inherent latency, allowing the robot to track a time-varying trajectory more precisely. Still, the complexity of achievable trajectories is intrinsically limited by the hopping frequency.

### Hopping Tests and Model Verification

To validate the identified parameters and the derived dynamic model, a preliminary controlled hopping experiment with the developed controller is performed. As detailed in Materials and Methods, the landing states (∥\dot{p}(t_{LD})∥ and θ_{LD}) of 130 consecutive jumps were recorded. The experiment employs the devised model to predict the takeoff states in terms of the body rotation Δψ and takeoff angle θ_{TO} and compares the predictions with the measurements as presented in FIG. 2C (∥\dot{p}(t_{TO})∥ cannot be accurately measured due to the existence of the powered climbing). The measurements are highly aligned with the predictions, with the root mean square errors (RMSEs) of only 1.0 and 1.6° for Δψ and θ_{TO}. The consistency between the model predictions and measurements validates that the derived equations and associated assumptions are suitable for capturing the stance dynamics of the Hopcopter.

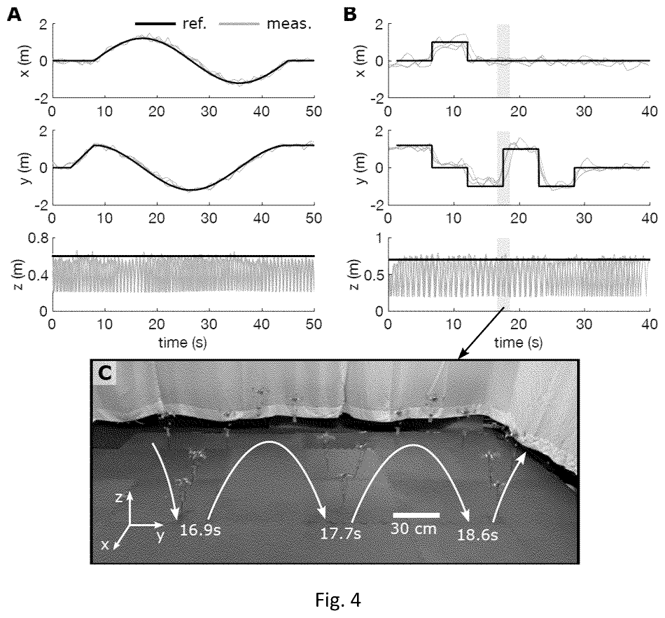

Next, the tracking performance was evaluated using circular and step trajectories. For the circular trajectory, the robot was instructed to hop at a constant altitude (0.60 m) around a circle with a radius of 1.20 m at an average speed of 0.2 ms⁻¹. The step trajectory demands the robot to maintain a jump height of 0.75 m and laterally translate by up to 2 m several times in 40 s. Three repeated trials were conducted for each trajectory. The resultant trajectories are shown in FIG. 4, in A and B, which show trajectory tracking experiments under the hopping mode (FIG. 4, in A, shows reference and realized circular trajectories, and FIG. 4, in B, shows reference and realized step trajectories). The tracking performance is determined by calculating the root mean square errors (RMSEs) of three repeated tests: the RMSE of the landing position is 16 cm for the circular trajectory and 49 cm for the step trajectory. For the jump height, the RMSEs are 4.1 cm and 4.8 cm, respectively. FIG. 4, in B, suggests that the amplified error of the step trajectory is due to the inability to respond promptly to significant alterations in the desired trajectory. These results demonstrate that the proposed controller can achieve accurate trajectory tracking with low altitude error and moderate landing error, even with large displacements between steps and the absence of control authority during the aerial phase.

### Hopping Agility

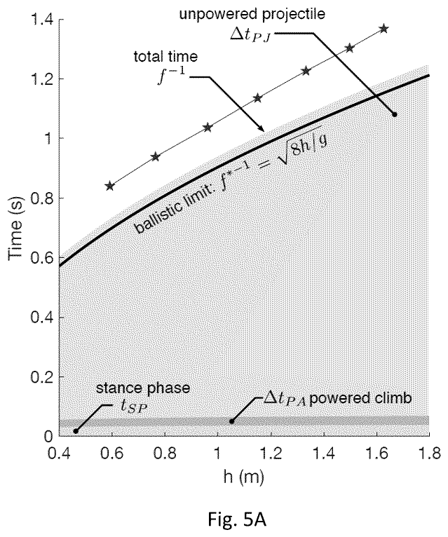

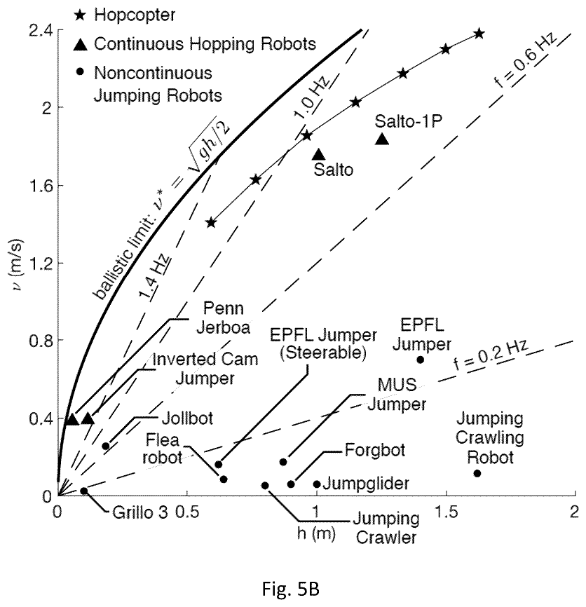

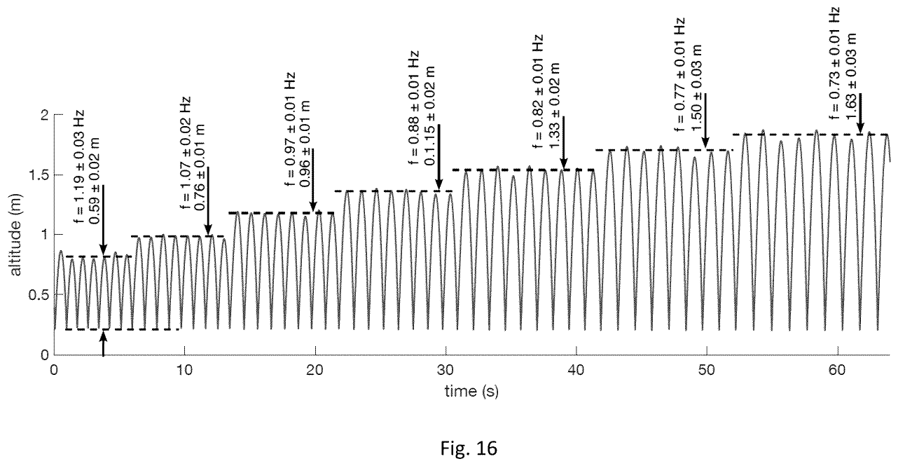

Next, an experiment is conducted to investigate the relationship between the hopping height and frequency of the robot, and to calculate its hopping agility, defined as the cycle-averaged vertical speed of the robot v=2hf (The definition of hopping agility presented here deviates from that of vertical jumping agility as defined in (31). The latter refers to the vertical climbing speed.). The robot is commanded to hop in place for over 60 s using the developed position controller. The test is divided into seven segments, each corresponding to a different hopping height ranging from 0.59 m to 1.63 m. In each segment, the robot hopped at a constant height for at least six cycles (FIG. 16). Then the time period of one hopping cycle for each segment system is measured and is plotted against the corresponding height (see FIG. 5A). It includes the period predicted by the model, which can be broken down into the time the robot spends in the stance phase (t_{SP}=t_{TO}−t_{LD} in Equation S12 in Note S3), powered climbing phase (Δt_{PA} in Equation 13), and the ballistic phase (Δt_{PJ} in Equation 14). Additionally, we identified the ballistic limit f*⁻¹=\sqrt{8h/g} (31), which occurs when the robot spends negligible time in the stance phase and the entire flight phase is ballistic.

As seen in FIG. 5A, the measured periods are approximately 100 ms longer than the model prediction. This discrepancy is mainly attributed to the fact that the model neglects the thrust generated for the attitude control effort when the robot is descending, which prolongs the falling time. The model prediction is 40 ms longer than the ballistic limit, which corresponds to the time the robot spends in the stance phase. Therefore, we can infer that these two factors collectively lengthen the robot's hopping period compared to the theoretical limit.

The hopping agility is computed as the product of the height and frequency. Due to the short stance time (<45 ms), the Hopcopter achieved a hopping agility of 2.38 m/s when h=1.63 m, which is 30% higher than 1.83 m/s for 1.25 m attained by Salto-1P (with a stance time over 120 ms) (31, 32) and other jumping robots (FIG. 5B and Table S2). All in all, the Hopcopter exploits the natural dynamics of a springy telescopic leg with high stiffness to minimize the ground contact time (see Note S3), which enables high agility due to the reduced stance time during hopping.

### Synergistic Hybrid Locomotion for Agile Maneuvers

Strategically combining hopping and flying can uniquely enhance maneuverability and agility, as the hopping mode can generate bursts of acceleration for flight. By momentarily switching to hopping mode during flight for a single jump, the monopedal robot can generate an instantaneously large acceleration from the ground normal. Using the developed hopping model, the takeoff direction is regulated through the landing attitude. This operation assists the robot in decelerating, accelerating from hover, or turning tightly, providing enhanced agility despite the limited thrust-to-weight ratio (for example 1.2).

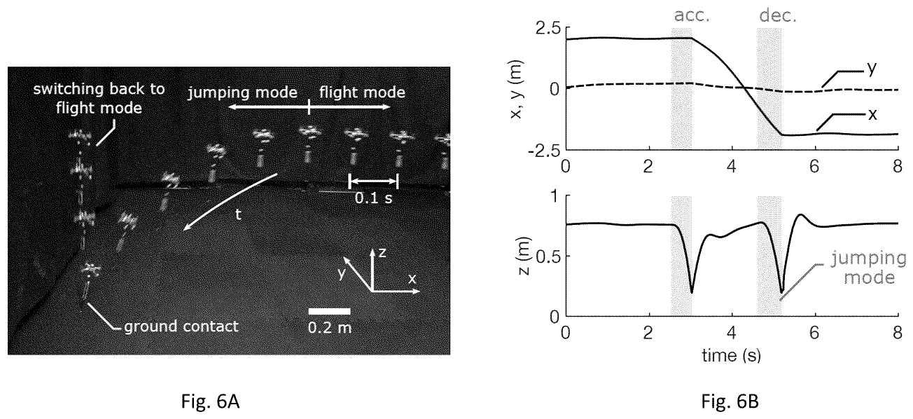

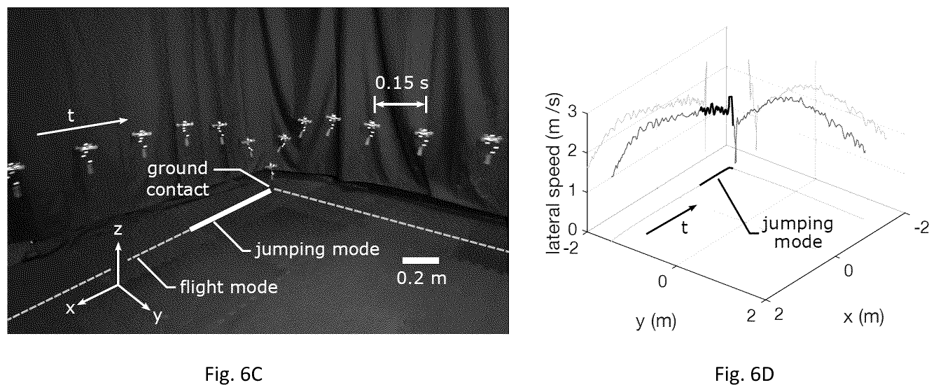

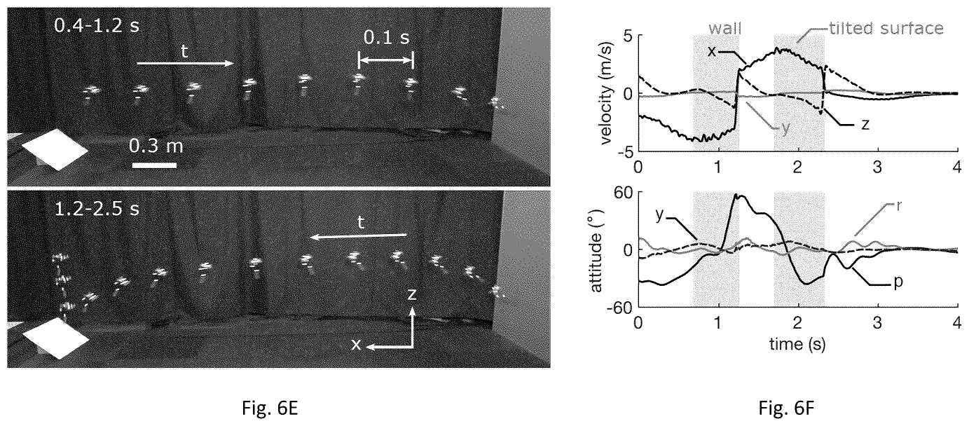

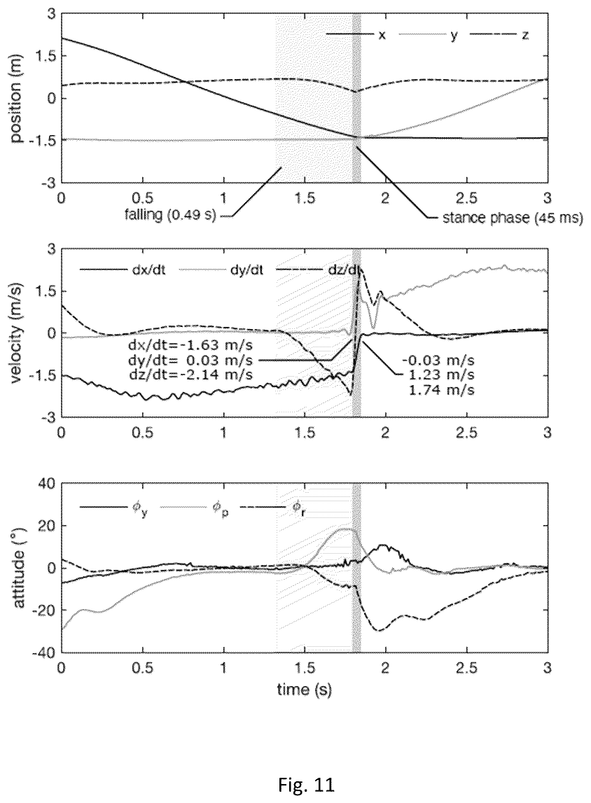

The first maneuver demonstrates the use of elastic leg and ground normal to accelerate and then decelerate the robot in flight. As shown in FIG. 6A and FIG. 6B, the robot is initially commanded to hover. To accelerate forward, the hopping mode is activated and the robot enters a free fall (marked in gray regions in FIG. 6B). Once landed at a pitch angle of 14°, the passive stance dynamics induces an impulsive takeoff with the forward speed of 1.14 ms⁻¹ with less than 45 ms spent in the SP, producing the lateral SP acceleration of 26.0 ms⁻² (the landing and takeoff velocities and SP acceleration are computed as detailed in Note S5). Including the fall period (0.50 s as marked by shadings in FIG. 6B and FIG. 10), the average lateral acceleration is 2.2 ms⁻². After the liftoff, the robot continues its flight and reaches the forward speed of over 1.99 ms⁻¹ before executing the second jump to land at a pitch angle of 19° and deftly decelerate to lateral speed of 0.05 ms⁻¹. The sudden stop results in a lateral SP deceleration of 43.5 ms⁻² and an average deceleration of 3.3 ms⁻² (including the falling period of 0.52 s as marked in FIGS. 6A-6F and 10).

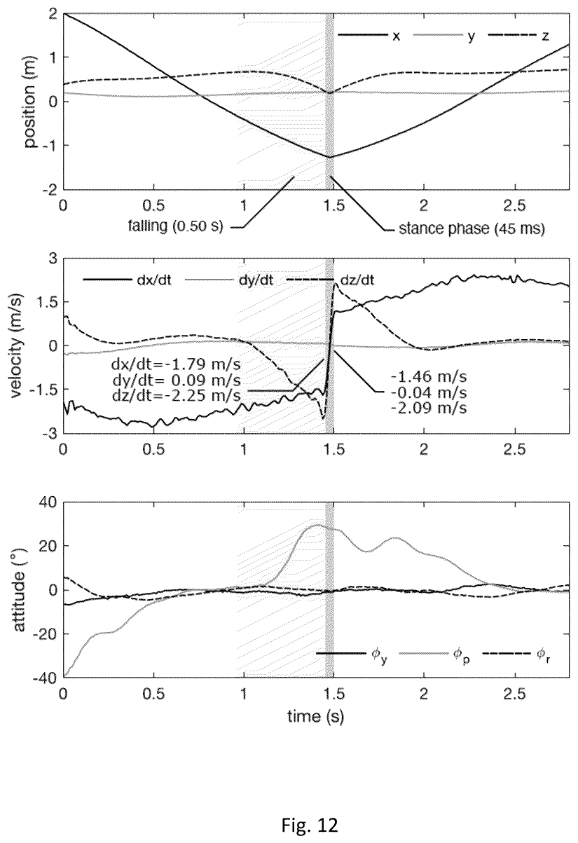

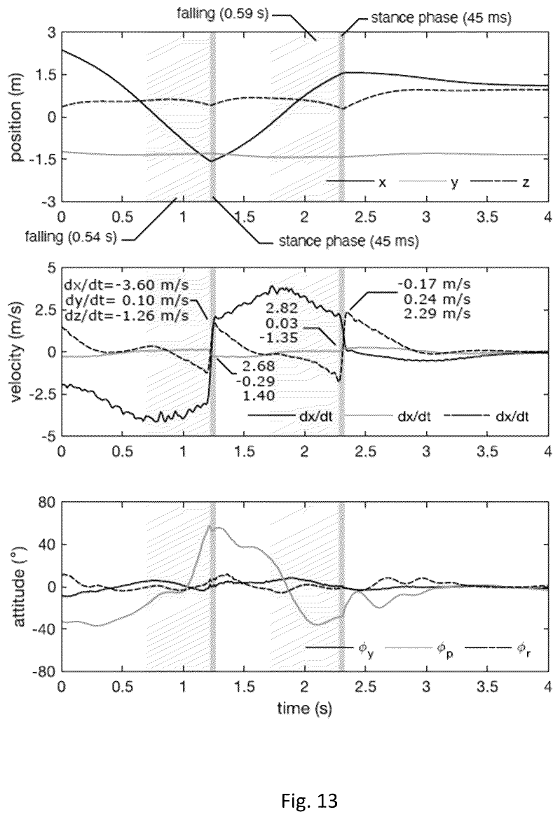

Next, the agility is illustrated through rapid and tight turns. The robot leverages the ground to swiftly change the travel direction by 90° as depicted in FIGS. 6C and 6D. Beginning with the flight speed of 1.9 ms⁻¹, the leg-assisted right turn alters the flight course in the space of 0.54 s (from falling to completion of the SP). The robot lands with the lateral speed of 1.63 ms⁻¹ and results in the post jump speed of over 1.23 ms⁻¹ as shown in FIG. 11. This equates to the lateral SP acceleration of 44.4 ms⁻² (in 45 ms) and average acceleration of 4.2 ms⁻². The large SP acceleration results in a sharp right-angle trajectory instead of a curve as visible in FIG. 6C. An even higher acceleration is achieved when the hybrid locomotion is implemented for suddenly reversing the flight direction (FIG. 12). The jump with a pitch angle of 28° at landing entirely turned the flight around in 0.55 s (from falling to completion of the SP), from the lateral landing velocity of 1.79 ms⁻¹ to the post jump speed of 1.46 ms⁻¹ in the opposite direction, equating to a lateral SP acceleration of 72.3 ms⁻² (in 45 ms) and an average lateral acceleration of 6.9 ms⁻².

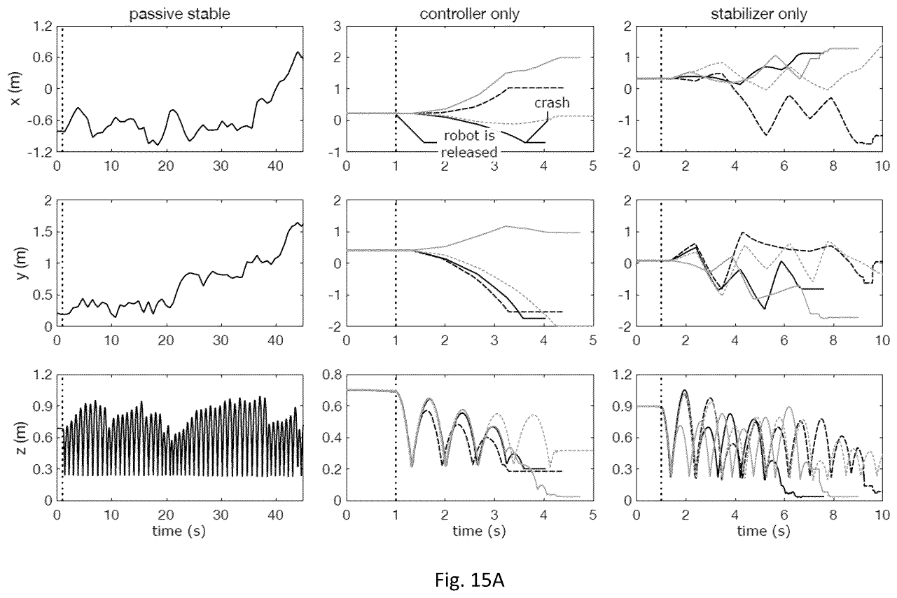

To further push the agility limit, hybrid jumps on a wall and a tilted surface are realized. Non-horizontal surfaces extend the range of non-slip landing and takeoff angles (Note S4). This effectively raises the achievable lateral acceleration. In the experiment, the robot flies toward a wall at a speed over 4 ms⁻¹. Within 0.54 s or 1.8 m prior to reaching the surface, the attitude controller reorients the robot for landing and the robot touches down on the wall with the tilt (pitch) angle of 57° and landing speed of 3.6 ms⁻¹ (FIGS. 6E and 6F and FIG. 14). The wall jump reverses the lateral speed of the robot to 2.68 ms⁻¹ within 45 ms. Immediately after the bounce, the robot spends 0.43 s accelerating toward another inclined surface (30°) and executes a second jump in 0.63 s (from falling to completion of the SP) to decelerate the flight from 3.9 ms⁻¹ to end the maneuver with a hover. The average lateral accelerations in these two periods are 11.4 and 5.7 ms⁻², whereas the lateral SP accelerations reach 139.8 and 66.6 ms⁻².

The results demonstrate that the jump-flying locomotion enables average and instantaneous lateral accelerations that are remarkable compared to its thrust-to-weight ratio of only 1.2. The Hopcopter can accomplish instantaneous and average accelerations of over 14 g and 1.2 g by using the ground normal and the elastic leg in intermittent jumps. This is notably higher than the reported accelerations of other micro aerial robots with similar or higher thrust-to-weight ratios (56, 57, 67). The hybrid locomotion is especially advantageous for robots with limited thrust power, such as small and lightweight platforms, as it allows them to perform rapid and tight maneuvers that would otherwise be impossible.

### Self-Stabilized Hopping Via Active Aerodynamic Stabilizer

According to the proposed hopping dynamic model, in hopping, the takeoff velocity of the robot is directly dependent on landing attitude and landing velocity. This implies that to stabilize the robot, a velocity measurement as feedback is necessary. To reduce the robot's dependence on sensors and external measurements, an actuated aerodynamic stabilizer is proposed to interact with the airflow to stabilize the robot. The strategy to enable the robot to hop in place without position or velocity feedback involves the adjustment of the landing angle θ_{LD} based on the robot's velocity \dot{p} in the falling phase. This is by appropriately balancing the attitude controller with the rotational torque created by the stabilizer.

### Aerodynamic Stabilizer

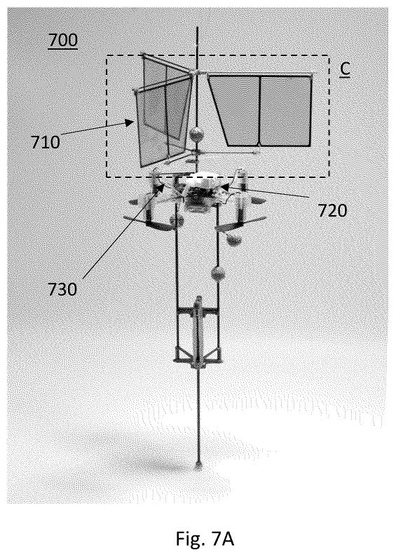

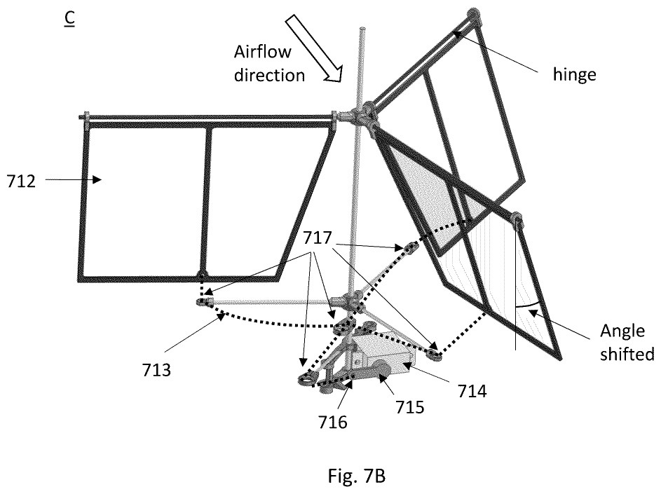

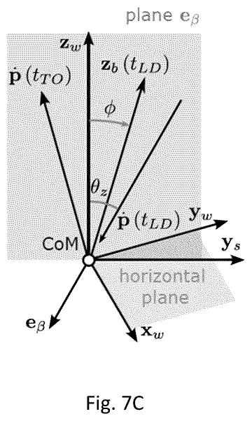

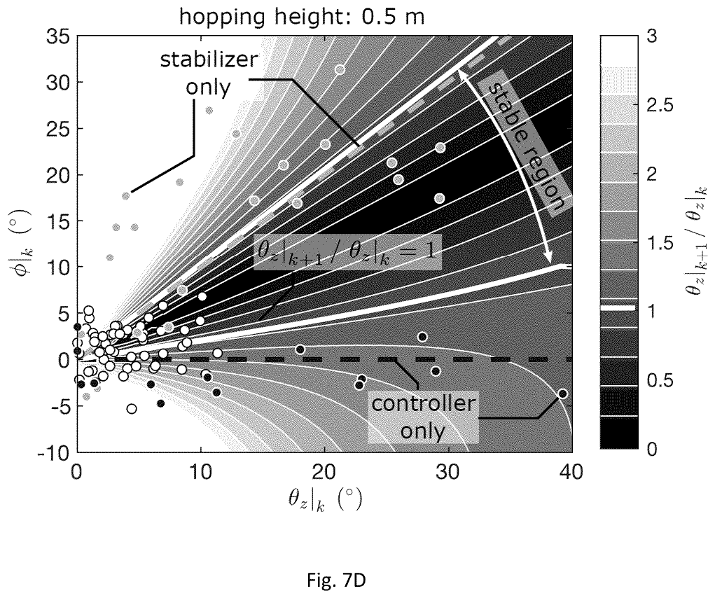

FIGS. 7A-7D shows example detachable active aerodynamic stabilizers and Poincaré maps. FIG. 7A illustrates a robot 700 equipped with an example aerodynamics stabilizer 710 according to an embodiment. FIG. 7B is an enlarged diagram of part C in FIG. 7A to show details of the stabilizer 710. FIG. 7C is a diagram displaying the relationships between landing velocity, landing attitude and takeoff velocity. FIG. 7D shows Poincaré maps depicting the evolution of the landing velocity angle θ_{z} in terms of θ_{z}|ₖ₊₁/θ_{z}|k, as a function of θ_{z}|k and ϕ|ₖ. Circular dots represent the recorded landing state in the hopping stability test. Black, gray and white colors represent the measurements when only the attitude controller, aerodynamic stabilizers, or both mechanisms were active. As shown in FIG. 7A and FIG. 7B, the detachable aerodynamic stabilizer 710 for the Hopcopter comprises three horizontally hinged surfaces 712 and weighs 4.9 grams. Three cables 713 (dashed lines) are mounted between the bottom of the three surfaces 712 and the end of a crank (i.e., a cable mount 716) on a drive unit, for example, a servomotor 714 (H-King 282AS). The three cables 713 are installed to pass through the five cable guides 717 (each cable passes through three cable guides 717). These surfaces 712 can be made rigid by pulling on cables 713 by the drive unit, or allowed to swing freely in response to airflow when the cables 713 are loosened. Tightening the cables 713 makes the bottom of surfaces 712 tightly close to the three cable guides 717 and activates the stabilizer 710, enabling them to bear aerodynamic load and generate torque to steer the robot's attitude based on airflow. Conversely, loosening the cables 713 deactivates the stabilizer 710, allowing the three surfaces 712 to rotate freely around the hinges, avoiding the generation of aerodynamic force and torque.

### Damper-Mediated Stability

The stabilizers are activated only during the descent while hopping. They use the upward airflow to create a torque that rotates the robot's attitude and reduces the landing angle θ_{TD} by making its major axis parallel and opposite to its translational velocity: z_{b}→−\dot{p}. In the meantime, the attitude controller applies a propelling torque to make the robot upright z_{b}→z_{w}=e₃. As a consequence of the competing efforts, the robot lands with its major axis z_{b} pointing between the vertical axis and the velocity vector −\dot{p}(t_{LD}) (see FIG. 7C). By tuning the control gains and the stabilizer configuration, the hopping dynamics can be stabilized without velocity measurements. That is, the Hopcopter gains the ability to operate in real-world environments using only the feedback from its onboard inertial sensor.

To manifest the damper-assisted stability, we numerically construct Poincaré maps assuming a constant hopping height of 0.5 m. The landing state is chosen as the fixed point of the limit cycle. Under the influence of the attitude controller and the aerodynamic stabilizer, the vectors z_{w},z_{b}, and \dot{p}(t_{LD}) are coplanar. The angle between the landing velocity and the vertical, θ_{z}=arccos(−z_{w}^{T}\dot{p}(t_{LD})/∥\dot{p}(t_{LD})∥) (see FIG. 7C), represents the horizontal speed that should approach zero over repeated hops in the case of stable hopping. In addition to θ_{z}, the landing attitude ϕ, defined as the signed angle between the robot's primary axis z_{b} and the vertical at landing (positive when arccos(−z_{b}^{T}\dot{p}(t_{LD})/∥\dot{p}(t_{LD})∥)<θ_{z} as seen in FIG. 7C and negative when arccos(−z_{b}^{T}\dot{p}(t_{LD})∥\dot{p}(t_{LD})∥)>θ_{z}), affects the takeoff state and subsequent landing state. The model of the stance dynamics is leveraged to predict the next landing sate for any combination of θ_{z} and ϕ as described in Materials and Methods.

The Poincaré maps plot θ_{z}|ₖ₊₁/θ_{z}|ₖ for different θ_{z}|ₖ and ϕ|ₖ at a particular hopping height, where k represents the hopping cycle (FIG. 7D and FIG. 14). The maps reveal the stable regions (θ_{z}|ₖ₊₁/θ_{z}|ₖ<1), establishing the conditions for converging hopping speed. Notably, the red dashed line in the Poincaré maps corresponds to ϕ|ₖ=0, representing the scenario in which the attitude controller dominates and the robot consistently lands with an upright orientation. On the other hand, the dashed line indicated by “stabilizer only” depicts cases where the stabilizer dominates, aligning the landing velocity and attitude (θ_{z}|ₖ=ϕ|ₖ). These dashed lines lie near the boundaries of the stable region, indicating that reliance on either strategy alone would not result in stability with sufficient robustness. However, the Poincaré maps exhibit a significant overlap between the stable region and the area between the dashed lines. By tuning the control gains and stabilizer configuration, the interplay between the controller and the mechanism stabilizes the hopping speed and attitude over repeated jumps without velocity measurements.

### Hopping Stability Test

To substantiate the insights from the Poincaré analysis, three sets of experiments are conducted to evaluate the performance of the hopping robot under each control strategy (attitude control and aerodynamic stabilizer) individually, as well as their combination. For each set of experiments, the robot starts to hop after a drop from about 75 cm. The hopping trajectory is tracked to determine the robot's attitude and velocity in the landing phase.

When utilizing only the attitude controller (dashed line indicated by “controller only”), the robot is expected to land consistently in an upright orientation or ϕ=0, but without any guarantee on the horizontal hopping speed or θ_{z}. Experimental results confirm this (FIG. 7D), showing that the robot could hop for 3-5 cycles before the horizontal speed diverges as θ_{z}|ₖ₊₁/θ_{z}|ₖ>1.

Relying solely on the stabilizer (the attitude controller was only active in the CP, i.e., when the robot is ascending) is predicted to marginalize the difference between θ_{z} and ϕ, but not directly reducing θ_{z}. Again, experiments validate this (FIG. 7D). Some discrepancies between the model prediction (θ_{z}=ϕ) and the results reflect a limited effectiveness of the aerodynamic stabilizer, which is dependent on the size and time the robot spent descending. Overall, the robot displays poor stability and crashes after 6-10 hopping cycles.

In contrast, experiments integrating both the attitude controller and stabilizer yield highly robust hopping as theorized. The robot retains near zero horizontal velocity component and near upright attitude across multiple successive jumps (white dots in FIG. 7D), achieving over 56 hops in 45 s within a 3×3-m arena in the absence of position and velocity feedback.

### Field Hopping Demonstration

To further demonstrate the robustness and reliability of the stabilizing strategy, three field tests are conducted in varying environments, including stairs, a corridor, and outdoor terrain. In each test, a human operator commands the desired landing attitude for the controller, though the actual landing posture depends on both the attitude setpoint and aerodynamic stabilizer as previously described. The adjusted desired landing attitude results in a bias that directs the robot to hop toward the prescribed direction. This control scheme allows the Hopcopter to ascend/descend a flight of stairs, navigate the narrow corridor space, and traverse rough terrain. Through these field experiments, it is verified that the active stabilizer enables stable and resilient mobility without requiring vision or additional sensors for velocity feedback.

As described, the embodiments of the invention provide a hybrid hopping and flying robot (Hopcopter) that combines hopping and flying capabilities to achieve high-performance locomotion. Its passive telescopic leg distinguishes it from existing bio-inspired jumping robots that rely on latched or unlatched elastic actuation as it dispenses the need for a trigger, actuation in stance, or variable mechanical advantage, making it mechanically simpler and more reliable. The thrust-based actuation of the passive telescopic leg allows fine-tuning of jump height and enables the Hopcopter's exceptional hopping agility, surpassing the state-of-the-art jumping robots. The short stance phase enabled by the absence of actuation in the stance phase permits higher hopping frequencies, resulting in its high agility. The robot achieves a maximum velocity of 2.38 m/s at a jump height of 1.63 m, exceeding the highest agility reported in jumping robots (FIG. 5B and Table S2), including Salto-1P (31, 32, 68). The use of thrust permits fine tuning of jump height. The Hopcopter demonstrates jumps from 0.6 to 1.6 m in experiments, showcasing its wide jump height range.

The Hopcopter's ability to both fly and hop facilitates rapid changes in flight speed and direction. The robot's jumping ability can be leveraged to mitigate damage from collisions with walls or ground by employing jumping maneuvers. The integration of attitude control and aerodynamic stabilizers establishes the robot's hopping control autonomy. Poincaré analysis and experiments show that the attitude controller and aerodynamic stabilizers work together synergistically to stabilize the Hopcopter's hopping dynamics. Without external feedback, the robot achieves over 56 consecutive jumps with near-zero velocity and upright landing—demonstrating the value of integrating attitude control and aerodynamic surfaces.

Crucially, the passive leg design of Hopcopter could be readily applied to conventional rotorcraft. With simple addition of an elastic leg and control changes, a standard quadcopter could transform into a hopping robot, unlocking new performance frontiers through hybrid locomotion. Overall, the Hopcopter represents an improved platform that transcends the limitations of aerial or terrestrial locomotion alone, demonstrating the potential of integrating flight and hopping capabilities.

### Endurance and Power Efficiency

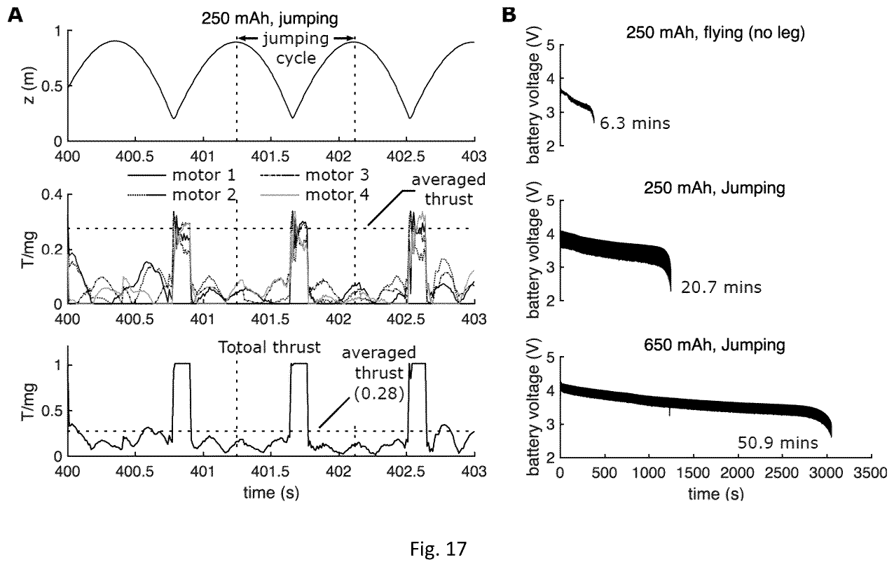

Unlike the aerial mode, the Hopcopter generates thrust intermittently rather than continuously during the hopping mode. This mode of operation presents an opportunity to substantially extend Hopcopter's operation time while reducing power consumption. To evaluate the endurance, a continuous jumping test is conducted with a fully charged 250-mAh single-cell Li-Ion battery (8.3 g). The robot hops continuously for over 1246 s (20.8 minutes). With a 650-mAh Li-Ion battery (16.8 g), the endurance increases to over 3052 s (50.9 minutes). However, the total mass of the robot (43.1 g) with a high-capacity battery exceeds the maximum takeoff weight for flight (42.0 g). Battery voltages recorded onboard during the tests are shown in FIG. 17B. Notably, the proposed terrestrial locomotion approach shows a four to eight-fold increase in endurance in comparison to the benchmark quadcopter (Crazyflie 2.1 with retroreflective markers but without the leg, 32.1 g) which only hovers for 379 s with a 250-mAh battery.

The lack on a reliable onboard current sensor and the weight limitation render direct measurement of the robot's operational power consumption impractical. Nevertheless, the duty cycle of the motors is used as a metric to compare the flight and terrestrial operations. This is because the robot is required to constantly generate T≈mg when hovering, whereas it only generates T=mg momentarily after takeoff while hopping. Defining the vehicle-based duty ratio D=(1/T)∫_{T}Σ(fᵢ/mg)dt, D=1 is obtained for the benchmark quadcopter flight. In endurance testing, the Hopcopter spends over 85% of time in ballistic and stance phases with minimal thrust for attitude control (Σfᵢ<0.11 mg outside the powered phases, see FIG. 17A). For these reasons, the overall duty ratio across 1246 s was only 0.28, representing over three-fold improvement in efficiency and endurance. In comparison, the hybrid quadcopter robots, PogoDrone (43) and LEO (53) saves only 20% and 44% power respectively via jumping and walking locomotion compared to flying, with a duty ratio exceeding 0.5.

### Materials and Methods

### Experimental Setup and Measurements.

The experiments are carried out in a 3×3×2.5-m³ arena with ten motion capture cameras (for example, OptiTrack Prime 13w). The pose measurements are used for both control and ground truth measurements. The high-level controllers, including the hopping and flight controllers, are implemented by Python on the ground computer and executed at 100 Hz. The custom attitude controller is implemented onboard and operated at 1 kHz. The robot and the ground station are communicated through a radio module (for example, Bitcraze Carzyradio PA) via Crazyflie Python API.

### Drop Tests for Parameter Identification.

As the stance phase dynamics captured by Equations 6 and 7 are subject to a few unknown lumped physical parameters, namely Ω=\sqrt{k/m}, f_{c}/m, and lₚ (l₀=22 cm is a design parameter), a drop test is devised to identify these model parameters according to the axial dynamics of the robot (Equation 6) prior to applying the equations to for predicting and controlling the hopping motion.

The setup of the drop tests is schematically presented in FIG. 8A. A robotic gripper can be provided (or fabricated) to hold the robot via a cable and release when triggered. The end of the cable is tied through the CoM of the vehicle to ensure the robot is in an upright orientation. A high-speed camera (for example, MotionBLITZ EoSens mini 2) captures the trajectory of the robot at 1,000 frames per second, covering the landing site. Both the gripper and the camera can be controlled by the same computer. The system is schematically illustrated in FIG. 8A. Using the Kanade-Lucas-Tomasi tracker (69), feature points are identified and traced on the robot between frames. Two-dimensional trajectories are reconstructed by calculating the geometric center of the tracked feature points. FIG. 8B shows an example diagram of the Hopcopter in stance with the tracked features.

The tests are carried out at three drop heights: 0.68, 0.82 and 0.95 m, with four drops at each height. The altitude of the robot in the free-drop experiments is indicated with twelve reconstructed trajectories as plotted in FIG. 8C. The robot spends 32.0±0.7 ms, 32.5±0.5, and 33.0±0.7 ms in the stance phase for the drop heights of 0.68, 0.82 and 0.95 m. The leg contraction l₀−l(t) is calculated from the data to plot the contraction against the acceleration in FIG. 8D. The outcome suggests two linear trend lines with the same gradient with a vertical offset. The lower and upper lines correspond to the leg compression and retraction, respectively. The evident and uniform gap between downstroke and upstroke (dark and light) accelerations reflects the energy loss or hysteresis in the form of coulomb friction. This leads to the proposed elastic force model in Equation 4. The least squares method is applied to estimate the model parameters. The best fitted linear model (solid lines in FIG. 8D) produces k/m=5.00×10³ s⁻², fₕ/m=12.7 m/s², and lₚ=1.97 cm.

The identified parameters, listed in Table S1, corroborate that the weight of the robot is negligible compared to the force of the pre-stretched elastomer as klₚ/mg≈10.

### Low-Level Control for Flight, Hopping, and Hybrid Maneuvers.

The same set of equations are applied to determine the rotor commands for flight and when the attitude of the robot during the aerial hopping phase is regulated. To achieve the designated attitude, a proportional-integral-derivative controller (55) is first implemented to compute the required body-centric torque τ_{p,d}.

Depending on the operational demand, the target thrust magnitude T_{d} can be zero, mg, or a particular value. To evaluate the force allocation between four rotors, we define f=[f₁,f₂,f₃,f₄]^{T} and a 4×4 configuration matrix A for power distribution

$${[ {τ}_{p} T ]}^{T} = Af . \qquad ( 18 )$$

To ensure that fᵢ>0 even when T_{d}=0, the following attitude-priority allocation (similar to (57)) is employed to compute f.

$$\begin{matrix}f = {arg min}_{f} & \vert {T}_{d} - T \vert \\ subject to & {f}_{i} \geq 0 and {τ}_{p , d} = {τ}_{p} ,\end{matrix} \qquad ( 19 )$$

despite that the collective thrust generation may not be correctly set to T_{d}, this assures the torque is correctly generated (τ_{p,d}=τₚ) and minimizes the error of thrust (T−T_{d}) when the desired thrust and torque may cause saturation of motors, especially for the unpowered projectile where T_{d} is set to zero.

### Model Verification.

The robot is commanded to hop at varying altitude setpoints in the range of 0.5 to 0.7 m and translate laterally in the range of 0 to 1 m per step for over 90 s. The trajectory is recorded. The data are processed to obtain the landing states and takeoff states. The landing and takeoff timestamps are identified from the CoM location. The transition velocities (\dot{p}(t_{LD}), p(t_{TO})) and attitude states (z_{b}(t_{LD}), z_{b}(t_{TO})) with respect to the inertial frame are deduced. Since, in practice, these four vectors may not be perfectly coplanar as modeled in FIG. 2A, the rotational axis e_{ψ} is computed as a unit normal vector of the best-fitted plane:

$${e}_{ψ} = {arg min}_{n} \frac{1}{2} {( {( {n}^{{}_{T}} \dot{p} ( {t}_{L D} ) / ‖ \dot{p} ( {t}_{L D} ) ‖ )}^{2} + {( {n}^{{}_{T}} \dot{p} ( {t}_{T O} ) / ‖ \dot{p} ( {t}_{T O} ) ‖ )}^{2} + {( {n}^{{}_{T}} {z}_{b} ( {t}_{L D} ) )}^{2} + {( {n}^{{}_{T}} {z}_{b} ( {t}_{T O} ) )}^{2} )}^{\frac{1}{2}} . \qquad ( 20 )$$

The averaged value of the objective function in Equation 20 is 0.8°, indicating minimal misalignment. After the reprojection on to the rotational plane normal to e_{ψ}, the angles θ_{LD}, Δψ and θ_{TO} for each jump are obtained. From the data of 130 jumps in 90 s, a wide region of the landing state (1.5<∥\dot{p}(t_{LD})∥<3.3 ms⁻¹ and 0°<θ_{LD}<20°) is covered.

### Poincare Maps for Hopping Stability Analysis.

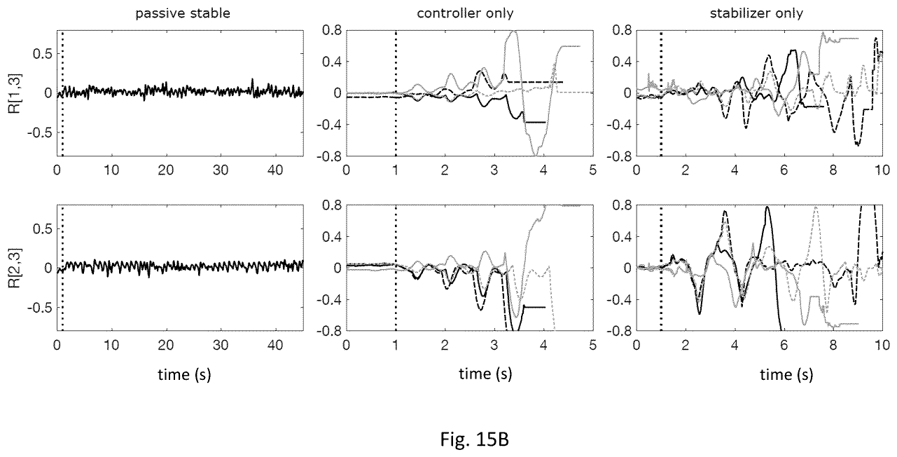

The constructed Poincaré maps assume a constant jumping height z_{d}. Hence, the vertical landing speed at cycle k is determined by ż(t_{LD})=\sqrt{2gz_{d}}. Given the landing attitude ϕ|ₖ and the angle of the landing velocity θ_{z}|ₖ, the landing angle θ_{LD}|ₖ|ϕ|ₖ−θ_{z}|ₖ| is calculated under the assumption that vectors z_{w},z_{b}(t_{LD})|ₖ, and \dot{p}(t_{LD})|ₖ, are coplanar and orthogonal to the rotational axis e_{ψ}. The takeoff states, z_{b}(t_{TO})ₖ| and \dot{p}(t_{TO})|ₖ, are obtained from Equation 8 and Equation 10. Following takeoff, the robot briefly throttles up in an upright orientation to compensate the energy lost (PA) before entering the ballistic trajectory (PJ). The horizontal velocity remains constant during flight. This implies the horizontal speed at takeoff at cycle k is equal to the horizontal speed at landing at cycle k+1. The vertical landing speeds at cycle k+1 and k are the same as dictated by the jump height z_{d}. The angle of the landing velocity θ_{z}|ₖ₊₁ is then the direction of the landing velocity relative to the vertical. This allows to compute θ_{z}|ₖ₊₁ or θ_{z}|ₖ₊₁/θ_{z}|ₖ for any θ_{z}|ₖ and ϕ|ₖ, which results in the Poincaré maps describes the stability of θ_{z} over jumping cycles (FIGS. 7D and 15).

### Supplementary Notes

### Moment of Inertia (Note S1)

After landing, the moment of inertia of the robot with respect to the ground contact point is obtained via the parallel axis theorem, taking into consideration the ground as the location of the axis of rotation,

$$I = {I}_{c m} + {ml}^{2} diag ( 1 , 1 , 0 ) , \qquad ( S1 )$$

where I_{cm}=diag(Iₓ, I_{y}, I_{z}). For a micro quadcopter (Bitcraze, Crazyflie 2.1), Iₓ, I_{y}, I_{z}≈2 g·cm², whereas ml²≈1×10⁴ g·cm² for l₀=0.22 m and m=27 g. That is, thanks to the long leg design, the term ml² dominates. Consequently, the robot can be treated as a point mass (instead of a rigid body) when the yaw rotations are minimized.

### Simplification of the Stance Dynamics (Note S2)

When the spring force dominates the weight of the robot, the motion of the robot in stance is described by Equation 5. Treating the non-slip ground contact point as the origin of an auxiliary inertial frame of reference, the position of the CoM is described by the leg vector l(t)z_{b}. The axial and angular dynamics correspond to the motion of l(t) and z_{b}(t).

Starting with the angular motion, the angular rate about z_{b} upon landing is assumed to be minimized by the attitude controller. The initial angular momentum in the stance phase specified by the angular velocity \dot{ψ}(t_{LD})e_{ψ} (perpendicular to z_{b} as described in Landing Transition) as shown in FIG. 2B. Furthermore, since the external force (z_{b}fₑ) does not contribute to any torque, the angular momentum of the robot (magnitude and direction) is unchanged. The rotation axis is constrained to e_{ψ}. As a consequence d/dt (ml²\dot{ψ}(t))=0, or

$$m {l}^{2} ( t ) \dot{ψ} ( t ) = m {l}_{0}^{2} \dot{ψ} ( {t}_{L D} ) . \qquad ( S2 )$$

To derive the axial dynamics, p in Equation 5 is expressed using the leg vector as d/dt(l(t)z_{b}(t)). Since the leg axis z_{b}(t) evolves according to the angular velocity \dot{ψ}(t)e_{ψ}, it follows that d/dt(z_{b}(t))=\dot{ψ}(t)e_{ψ}×z_{b}(t) and Equation 5 becomes

$$m ( \ddot{l} {z}_{b} + 2 \dot{l} \dot{ψ} {e}_{ψ} \times {z}_{b} + l \ddot{ψ} {e}_{ψ} \times {z}_{b} + l \dot{ψ} {e}_{ψ} \times ( \dot{ψ} {e}_{ψ} \times {z}_{b} ) ) = {z}_{b} {f}_{e} . \qquad ( S3 )$$

To extract the axial dynamics, the projection of Equation S3 is taken along z_{b}.

$$m \ddot{l} = m {\dot{ψ}}^{2} l + {f}_{e} . \qquad ( S4 )$$

The term \dot{ψ}²l denotes the centrifugal acceleration brought by the rotation.

Lastly, the significance of \dot{ψ}²l is considered in comparison to fₑ/m. The prototype is fabricated with a large pre-stretched elastic force. As the identified parameters listed in Table S1, fₑ/m>klₚ/m=96 ms⁻². On the other hand, the upper bound of \dot{ψ} can be estimated from the speed of the robot at touch down. For a jump height of h=1 m, |\dot{p}|≈\sqrt{2gh}=4.4 ms⁻¹. If the landing angle θ_{LD} is around 200 or less (as evidenced in the experimental results in FIG. 2C), the angular speed, \dot{ψ}<|\dot{p}|sin(20°)/l₀ and \dot{ψ}²<|\dot{p}|²/l₀=10 ms⁻². Since, the centrifugal acceleration is an order of magnitude smaller than the contribution from the elastomer, the dependence on \dot{ψ} can be neglected and Equation S4 reduces to Equation 6 after incorporating fₑ from Equation 4.

### Solutions of the Stance Phase Dynamics (Note S3)

Thanks to the simplification in Note S2, the stance dynamics is separated into axial and angular dynamics. The axial motion is captured by an unforced ordinary linear differential equation. The response of the systems obtained analytically.

Given the initial condition at landing with t=t_{LD} as the initial timestamp, obtained is

$$l ( {t}_{L D} ) = {l}_{0} and \dot{l} ( {t}_{L D} ) = {z}_{b} ( {t}_{L D} ) \cdot \dot{p} ( {t}_{L D} ) < 0. \qquad ( S5 )$$

During the downstroke (\dot{l}<0), the term sgn(\dot{l}) in Equation 6 is −1, the solution is

$$l ( t ) = ( \dot{l} ( {t}_{L D} ) / Ω ) sin ( Ω ( t - {t}_{L D} ) ) - ( {l}_{p} + {f}_{h} / k ) cos ( Ω ( t - {t}_{L D} ) ) + ( {l}_{0} + {l}_{p} + {f}_{h} / k ) , \qquad ( S6 )$$

with Ω=\sqrt{k/m}. The time when the leg is fully contracted can be found by solving for \dot{l}(t_{MD})=0. This results in

$${t}_{M D} = {t}_{T D} + \frac{1}{Ω} arctan ( - \frac{\dot{l} ( {t}_{L D} ) / Ω}{{l}_{p} + {f}_{h} / k} ) , \qquad ( S7 )$$

$$and$$

$$l ( {t}_{M D} ) = - \sqrt{{( \dot{l} ( {t}_{L D} ) / Ω )}^{2} + {( {l}_{p} + {f}_{h} / k )}^{2}} + ( {l}_{0} + {l}_{p} + {f}_{h} / k ) . \qquad ( S8 )$$

This condition becomes the initial state of the next phase, in which the leg recoils (\dot{l}>0). The solution of Equation 6 in this time period is

$$l ( t ) = ( l ( {t}_{M D} ) - {l}_{0} - {l}_{p} + {f}_{h} / k ) cos ( Ω ( t - {t}_{M D} ) ) + ( {l}_{0} + {l}_{p} - {f}_{h} / k ) , \\ \dot{l} ( t ) = - Ω ( l ( {t}_{M D} ) - {l}_{0} - {l}_{p} + {f}_{h} / k ) sin ( Ω ( t - {t}_{M D} ) ) \qquad ( S9 )$$

Then, the takeoff time is found by solving Equation S6 for l(t_{TO})=l₀. This yields

$${t}_{TO} = {t}_{M D} + \frac{1}{Ω} arccos ( \frac{- {l}_{P} + fh / k}{l ( {t}_{M D} ) - {l}_{0} - {l}_{P} + fh / k} ) , \qquad ( S10 )$$

$$and$$

$$\dot{l} ( {t}_{TO} ) = - Ω ( l ( {t}_{M D} ) - {l}_{0} - {l}_{p} + {f}_{h} / k ) sin ( Ω ( {t}_{TO} - {t}_{M D} ) ) . \qquad ( S11 )$$

Therefore, the total time spent in the stance phase is

$${t}_{SP} = {t}_{TO} - {t}_{LD} = \frac{1}{Ω} arctan ( - \frac{\dot{l} ( {t}_{L D} ) / Ω}{{l}_{p} + {f}_{h} / k} ) + \frac{1}{Ω} arccos ( \frac{- {l}_{p} + {f}_{h} / k}{l ( {t}_{M D} ) - {l}_{0} - {l}_{p} + {f}_{h} / k} ) , \qquad ( S12 )$$

which is upper bounded by

$${t}_{S P} \leq \frac{π}{Ω} = π \sqrt{\frac{m}{k}} = 45 ms .$$

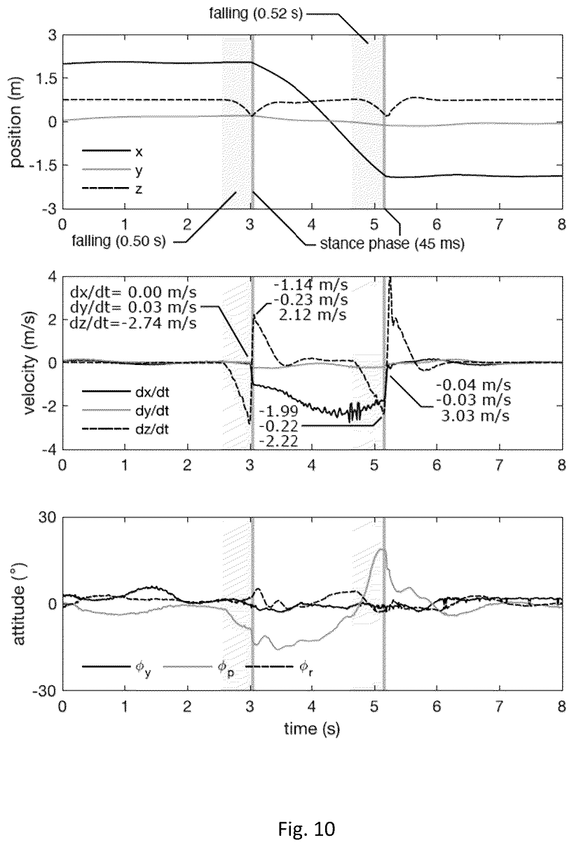

That is, the maximum stance time is inversely proportional to the square root of the stiffness k. Meanwhile, Equation S11 provides the knowledge required for computing the takeoff velocity. An example plot of l(t) in the entire stance phase is shown in FIG. 9.

As per Equation 7, once l(t) is determined, we can integrate forward the angular dynamics to determine Δψ:

$$Δ ψ = {\int }_{{t}_{L D}}^{{t}_{TO}} \dot{ψ} ( t ) dt = {l}_{0}^{2} \dot{ψ} ( {t}_{L D} ) {\int }_{{t}_{L D}}^{{t}_{TO}} {l}^{- 2} ( t ) dt \qquad ( S13 )$$

$$= {l}_{0}^{2} \dot{ψ} ( {t}_{L D} ) ( {\int }_{{t}_{L D}}^{{t}_{M D}} {l}^{- 2} ( t ) dt + {\int }_{{t}_{M D}}^{{t}_{T O}} {l}^{- 2} ( t ) dt ) , \qquad ( S14 )$$

in which the expressions for l(t) are taken from Equations S6 and S9.

### Friction Limit (Note S4)

The derived model describing the SP dynamics hinges on the non-slip assumption. This may not be satisfied in extreme maneuvers when the friction coefficient μ is low. Since the elastic force (aligned with z_{b}) dominates the SP dynamics, its vertical component becomes the ground normal and the lateral component should not exceed the friction limit. A slippage can be prevented by restricting the tilt angle of the robot arccos(e₃·z_{b}) to be lower than tan⁻¹μ in the entire stance phase. Since this angle is maximized either at t_{LD} or t_{TO}, this requires

$$ψ ( {t}_{L D} ) and ψ ( {t}_{T O} ) \leq t a {n}^{- 1} μ , \qquad ( S15 )$$

as the tilt angle is maximized either at the landing or takeoff.

### Measurements of Stance Phase Acceleration (Note S5)

Due to the the motion capture system's limited sample rate (≈100 Hz) and spatial resolution (≈1 mm), the timestamps of the touchdown and takeoff events surrounding the short stance phase (t_{SP}<45 ms, refer to the analysis in Note S3 and FIGS. 8A to 8D from the drop tests) cannot be precisely captured. To accurately estimate the stance phase acceleration, a few simplifying assumptions are employed and the estimation problem is converted into an optimization problem.

To begin, the recorded position of the robot is inspected for a short time period before and after a jump and the trajectory is divided into three phases: the stance phase sandwiched by aerial phase characterized as the pre-jump and post-jump periods. The stance time t_{SP}=t_{TO}−t_{LD} is conservative assumed 45 ms, but the exact landing and takeoff timestamps are not known.

The trajectories of the robot before and after the jump (\hat{p}_{LD}>\hat{p}_{TO}) are assumed to be parametric functions of time, with the robot only subject to a constant vertical acceleration of \hat{\ddot{p}}_{LD,TO}=−a_{LD,TO}e₃ (nominally g for free fall). Under this assumption, the following expressions can be derived for the position and velocity of the robot:

$${\dot{\hat{p}}}_{L D} ( t ) = {ν}_{L D} + {a}_{L D} ( {t}_{L D} - t ) {e}_{3} , \qquad ( S16 )$$

$${\dot{\hat{p}}}_{TO} ( t ) = {ν}_{TO} - {a}_{TO} ( t - {t}_{TO} ) {e}_{3} , \qquad ( S17 )$$

where v_{LD} and v_{TO} are the landing and takeoff velocities to be determined, and

$${\hat{p}}_{L D} ( t ) = {s}_{L D} + {ν}_{L D} ( {t}_{L D} - t ) + \frac{1}{2} {{a}_{L D} ( {t}_{L D} - t )}^{2} {e}_{3} , \qquad ( S18 )$$

$${\hat{p}}_{T O} ( t ) = {s}_{T O} + {ν}_{T O} ( t - {t}_{T O} ) - \frac{1}{2} {{a}_{L D} ( t - {t}_{T O} )}^{2} {e}_{3} , \qquad ( S19 )$$

where s_{LD} and s_{TO} and the landing and takeoff locations to be determined.

To account for possible deviations in a_{LD} and a_{TO} from g due to attitude and altitude control before landing and after takeoff, we simultaneously search for unknown parameters Θ={a_{LD},a_{TO},v_{LD},v_{TO},s_{LD}>s_{TO}}along with the landing timestamp. This is by conducting the least squares regression of the measured trajectory and the anticipated trajectory of the robot in the aerial phase before and after stance, with the interested periods being short time intervals just before (t_{LD}−Δt<t<t_{LD}) and after (t_{TO}<t<t_{TO}+Δt) the stance.

Assuming the length of the stance phase is t_{SP}=t_{TO}−t_{LD}, given a particular length of time window Δt, the measured trajectories of the robot between t_{LD}−Δt to t_{LD} and t_{TO} to t_{TO}+Δt should follows Equations S18 and S19. Based on this principle, t_{LD} can be estimated by

$${Θ}^{*} , {t}_{L D}^{*} = arg {min}_{Θ , {t}_{L D}} {\sum }_{{t}_{LD} - Δ t < t < {t}_{L D}} {( p ( t ) - {\hat{p}}_{L D} ( t ) )}^{2} + {\sum }_{{t}_{TO} < t < {t}_{TO} + Δ t} {( p ( t ) - {\hat{p}}_{TO} ( t ) )}^{2} subject to {t}_{T O} = {t}_{L D} + {t}_{S P} , \qquad ( S20 )$$

where the sums are over the data points from the respective time ranges. Δt=0.4 s is selected to ensure sufficient data points (≈80) are included to determine 15 unknowns. Extending Δt may not lead to an improved fit as the acceleration may not be constant over a prolonged period thanks to the propelling thrust. Once the optimal parameters are determined, the landing and takeoff velocities can be evaluated using Equations S16 and S17. This method allows to compute the velocities without needing to take numerical derivatives, which can be sensitive to noise in the measurements and the choice of low-pass filter cutoff frequency.

FIG. 8A is a schematic diagram of an experimental setup of the drop tests for parameter identification; FIG. 8B is a diagram of the robot from a high speed video and the tracked features; FIG. 8C shows the altitude of the robot in the free-drop experiments where dark and light curves represent falling and ascending (downstroke and upstroke) phases; FIG. 8D shows vertical acceleration versus the compressed length of the robot in the stance phase after the drops. FIG. 9 shows an example trajectory of the leg contraction l(t). The solid dark and light lines represent the analytical solutions of l(t) during the downstroke and upstroke, respectively. The dashed lines represent the extended solutions.

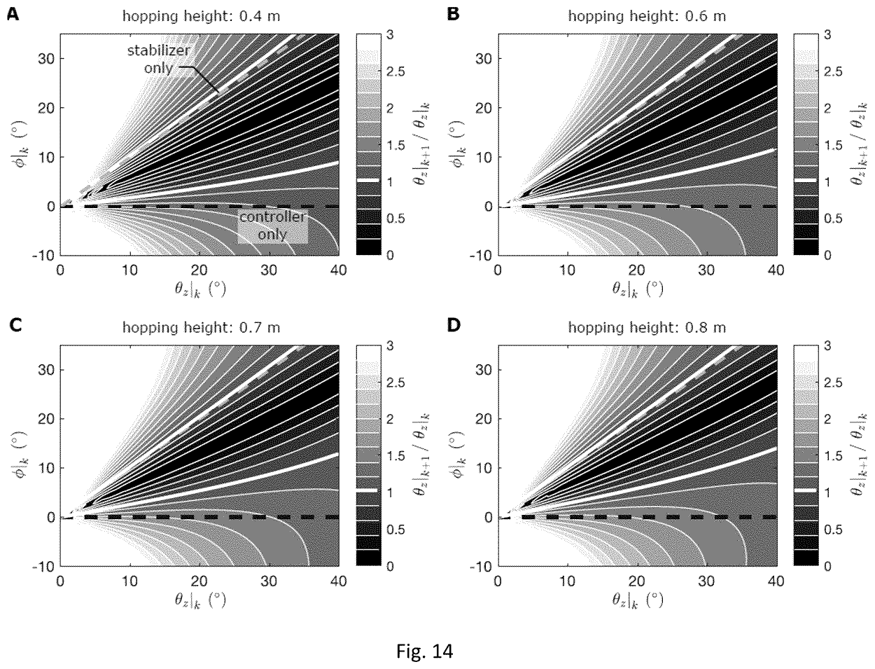

FIG. 10 shows a trajectory of hybrid locomotion of the robot with longitudinal acceleration and deceleration. FIG. 11 shows a trajectory of hybrid locomotion of the robot with a 90° turn. FIG. 12 shows a trajectory of hybrid locomotion with a U-turn. FIG. 13 shows a trajectory of hybrid locomotion with non-horizontal surfaces. FIG. 14 shows Poincaré maps depicting the evolution of the landing velocity angle θ_{z} in terms of θ_{z}|ₖ₊₁|_{z}|ₖ, as a function of θ_{z}|ₖ and ϕ|ₖ: FIG. 14, in A, shows predictions for the hopping height of 0.4 m; FIG. 14, in B, shows predictions for the hopping height of 0.6 m; FIG. 14, in C, shows predictions for the hopping height of 0.7 m; and FIG. 14, in D, shows predictions for the hopping height of 0.8 m.

FIG. 15A and FIG. 15B show trajectory of the robot in passive stability test for three scenarios of stable hopping (achieved with both the aerodynamic stabilizer and attitude controller), hopping with the attitude controller only, and hopping with the aerodynamics stabilizer only. The stable hopping scenario was obtained by implementing both the aerodynamic stabilizer and attitude controller. The four different patterned curves represent four repeated experiments. FIG. 16 shows altitude of the robot in agility evaluation. FIG. 17 shows results from endurance test: FIG. 17, in A, shows the altitude of the robot while hopping and the respective motor commands; and FIG. 17, in B, shows onboard battery voltage of the robots when jumping and flying.

TABLE S1
[Identified Parameters of the Hopcopter]

| Parameter | Description | Value | Unit |
|---|---|---|---|
| lₒ | original length of the leg | 22.00 | cm |
| lₚ | pre-stretch length of the elastomer | 1.97 | cm |
| k | spring constant of the elastomer | 170.06 | N/m |
| m | mass of the robot | 34.8 | g |
| ƒ_{c} | constant friction | 0.45 | N |

TABLE S2
[Jumping height, frequency and the hopping agility of reported
jumping robots]

| | Continuous | Mass | Jump | Frequency | Hopping |
|---|---|---|---|---|---|
| Robot | jumping | (g) | height (m) | (Hz) | agility (m/s) |
| Hopcopter | Y | 34.8 | 1.63 | 0.73 | 2.38 |
| | | | 1.50 | 0.77 | 2.31 |
| | | | 1.33 | 0.82 | 2.18 |
| | | | 1.15 | 0.88 | 2.02 |
| | | | 0.96 | 0.97 | 1.86 |
| | | | 0.76 | 1.07 | 1.63 |
| | | | 0.59 | 1.19 | 1.40 |
| Salto-1P (32) | Y | 98 | 1.25 | 0.73 | 1.83 |
| Salto (31) | Y | 100 | 1.01 | 0.87 | 1.76 |
| EPFL Jumper | N | 7 | 1.4 | 1/4 | 0.70 |
| (13, 31) | | | | | |
| Hybrid-Spring | N | 22.5 | 32 | 1/120 | 0.53 |
| Jumper (19) | | | | | |
| Inverted Cam | Y | 169 | 0.12 | 1.7 | 0.41 |
| Jumper (21) | | | | | |
| Penn Jerboa (34) | Y | 2419 | 0.055 | 3.5 | 0.39 |
| TAUB (22) | N | 23 | 3.35 | 1/20 | 0.34 |
| Jollbot (12, 23) | N | 465 | 0.184 | 1/1.44 | 0.26 |
| MSU Jumper (23) | N | 23.5 | 0.87 | 1/10 | 0.17 |
| EPFL Jumper | N | 14.3 | 0.62 | 0.13 | 0.16 |
| (Steerable) (24) | | | | | |
| Jumping Crawling | N | 59.4 | 1.62 | 1/28 | 0.12 |
| Robot (25) | | | | | |
| Flea Robot (23, 26) | N | 1.1 | 0.64 | 1/15 | 0.09 |
| Frogbot (23, 27) | N | 1300 | 0.9 | 1/30 | 0.06 |
| Jumpglider (28) | N | 67.5 | 1.0 | 0.03 | 0.06 |
| Jumping Crawler | N | 105 | 0.8 | 1/30 | 0.05 |
| (20) | | | | | |
| Grillo 3 (29) | N | 22 | 0.1 | 0.125 | 0.03 |

According to embodiments of the invention, a hybrid hopping and flying robot seamlessly integrates a nano quadcopter with a passive telescopic leg, overcoming the limitations of traditional jumping mechanisms that rely on stance phase leg actuation, which largely simplified the complexity of mechanical structure. By analyzing the dynamics, a propeller-based jumping control method has been developed to stabilize and control the position of the robot during a continuous jump. This unique design and actuation strategy allow for adjustable jump height, short stance phase duration and position controllability. Compared to conventional jumping mechanisms or jumping robots, the hybrid jumping-flying robot achieves a highly reliable controllability and jumping agility with a simple mechanism.

In flight mode, the robot functions as a regular micro aerial vehicle, allowing for stable hovering, agile maneuvering. Besides, thanks to the passive leg, the robot can perform a synergistic hybrid jumping and flying locomotion by performing intermittent mid-flight jumps. For instance, during high-speed flight, the robot leverages the ground contact or environment to generate an instantaneous burst of acceleration and hop to decelerate, turn, or accelerate—significantly improving agility beyond flight alone. Having a jumping leg also improves the endurance of the robot. In jumping mode, the robot generates thrust intermittently rather than continuously during the hopping mode. This mode of operation presents an opportunity to substantially extend robot's operation time and reducing power consumption when the robot is not necessary to keep aloft. Compared with flying, jumping mode can extend the operation time by four-fold.

To attain stable hopping using onboard sensors only, the robot is outfitted with an active aerodynamic stabilizer as a separate part. The stabilizer influences landing attitude, stabilizing hopping speed and attitude without external feedback or vision. The realized hybrid hopping-flying locomotion of the robot offers unprecedented versatility in navigating complex environments.

Some embodiments of the invention provide a hybrid hopping and flying robot comprising a micro quadcopter attached to a telescopic leg with an elastic element. The telescopic leg includes upper and lower sections, connected by guide wheel sets to allow vertical translation. Pre-stretched rubber bands are employed as an elastic element (elastomer). The design according to some embodiments of the invention enables the elastic force to dominate gravity and decouple the robot's dynamics from gravity's orientation which simplifies the jumping dynamics and enables a controlled jumping locomotion.

Some embodiments of the invention provide a model-based hopping controller with ability to control take-off velocity and landing positions of the robot, enabling trajectory tracking and complex hybrid locomotion. The controller may be configured to numerically solve for the landing attitude based on a model of dynamics of the robot during a hop. The controller may be configured to control the landing positions and takeoff velocities of the robot in three dimensions.

Use of ground reaction force through the elastic leg for efficient position control results in superior jumping agility compared to existing flying robots.

Various sensors can be carried for environmental detection for the hybrid hopping and flying robot. However, its unique of jumping locomotion enhances the agility of the movement of the robot and boosts its efficiency and prolongs its working time by over four-fold. In addition, thanks to the simple mechanical structure of the telescopic leg, this design can also be installed on conventional quadcopters as an additional component, allowing them to gain jumping locomotion.

According to the embodiments of the invention, by the combination of hopping and flying capabilities of the robot, mechanical simplicity and power efficiency can be achieved. By its hybrid locomotion, the robot transcends the limitations of aerial or terrestrial locomotion alone, allowing it to navigate complex environments with ease and with boosted agility. Its ability to hop and fly enables rapid changes in the moving direction, making it more versatile than traditional aerial robots.

The passive telescopic leg design of the robot allows it to perform high-performance locomotion without the need for a trigger, actuation in stance, or variable mechanical advantage. This makes it mechanically simpler and more reliable than other bio-inspired jumping robots that rely on latched or unlatched elastic actuation.

The robot surpasses the state-of-the-art jumping robots, achieving a maximum velocity (jumping agility) of 2.38 m/s at a jump height of 1.63 m. Its thrust-based actuation allows fine-tuning of jump height, and its short stance phase enables higher hopping frequencies, resulting in remarkable agility.

Unlike aerial mode, the robot generates thrust intermittently during hopping mode, extending its operation time and reducing power consumption. This feature allows the robot to achieve a four-fold increase in endurance compared to benchmark quadcopters, making it more energy-efficient for long-duration tasks.

The passive leg design of the robot can be easily integrated into conventional rotorcraft, enabling standard quadcopters to transform into hopping robots with simple additions and control changes. This adaptability unlocks new performance frontiers through hybrid locomotion and broadens the potential applications for aerial and terrestrial robots.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings). While some embodiments relate to human point clouds, it should be appreciated that methods/framework of the invention can be applied to other point clouds (not limited to human point clouds).

### REFERENCES

1. Chin, D. D. and Lentink, D., How birds direct impulse to minimize the energetic cost of foraging flight. Science Advances, 2017, 3, e1603041.
2. Bennet-Clark, H. and Lucey, E., The jump of the flea: A study of the energetics and a model of the mechanism. Journal of Experimental Biology, 1967, 47, 59-76.
3. Burrows, M., Jumping performance of froghopper insects. Journal of Experimental Biology, 2006, 209, 4607-4621.
4. Simmons, P. J., Rind, F. C., and Santer, R. D., Escapes with and without preparation: The neuroethology of visual startle in locusts. Journal of insect physiology, 2010, 56, 876-883.
5. Zhao, F., Wang, W., Wyrwa, J., Zhang, J., Du, W., and Zhong, P., Design and demonstration of a flying-squirrel-inspired jumping robot with two modes. Applied Sciences, 2021, 11, 3362.
6. Lau, A. S. H., Ma, Z., and Huang, X., The aerodynamic effects of forelimb pose on the gliding flight of draco lizards. Physics of Fluids, 2023, 35
7. Bartlett, N. W., Tolley, M. T., Overvelde, J. T., et al., A 3D-printed, functionally graded soft robot powered by combustion. Science, 2015, 349, 161-165.
8. Loepfe, M., Schumacher, C. M., Lustenberger, U. B., and Stark, W. J., An untethered, jumping roly-poly soft robot driven by combustion. Soft Robotics, 2015, 2, 33-41.
9. Chen, Y., Wang, H., Helbling, E. F., et al., A biologically inspired, flapping-wing, hybrid aerial-aquatic microrobot. Science robotics, 2017, 2, eaao5619.
10. Zufferey, R., Ancel, A. O., Farinha, A., et al., Consecutive aquatic jump-gliding with water-reactive fuel. Science Robotics, 2019, 4, eaax7330.
11. Scarfogliero, U., Stefanini, C., and Dario, P., Design and development of the long-jumping“grillo” mini robot. In Proceedings 2007 IEEE international conference on robotics and automation IEEE, 2007, pp. 467-472.
12. Armour, R., Paskins, K., Bowyer, A., Vincent, J., and Megill, W., Jumping robots: A biomimetic solution to locomotion across rough terrain. Bioinspiration & biomimetics, 2007, 2, S65.
13. Kovac, M., Fuchs, M., Guignard, A., Zufferey, J.-C., and Floreano, D., A miniature 7 g jumping robot. In 2008 IEEE international conference on robotics and automation IEEE, 2008, pp. 373-378.
14. Kovac, M., Schlegel, M., Zufferey, J.-C., and Floreano, D., A miniature jumping robot with self-recovery capabilities. In 2009 IEEE/RSJ international conference on intelligent robots and systems IEEE, 2009, pp. 583-588.
15. Kovac, M., Fauria, O., Zufferey, J.-C., Floreano, D., et al., The EPFL jumpglider: A hybrid jumping and gliding robot with rigid or folding wings. In 2011 IEEE international conference on robotics and biomimetics IEEE, 2011, pp. 1503-1508.
16. Woodward, M. A. and Sitti, M., Design of a miniature integrated multi-modal jumping and gliding robot. In 2011 IEEE/RSJ international conference on intelligent robots and systems IEEE, 2011, pp. 556-561.
17. Woodward, M. A. and Sitti, M., Multimo-bat: A biologically inspired integrated jumping-gliding robot. The International Journal of Robotics Research, 2014, 33, 1511-1529.
18. Truong, N. T., Phan, H. V., and Park, H. C., Design and demonstration of a bio-inspired flapping-wing-assisted jumping robot. Bioinspiration & biomimetics, 2019, 14, 036010.
19. Hawkes, E. W., Xiao, C., Peloquin, R.-A., et al., Engineered jumpers overcome biological limits via work multiplication. Nature, 2022, 604, 657-661.
20. Chae, S.-H., Baek, S.-M., Lee, J., and Cho, K.-J., Agile and energy-efficient jumping-crawling robot through rapid transition of locomotion and enhanced jumping height adjustment. IEEE/ASME Transactions on Mechatronics, 2022, 27, 5890-5901.
21. Shin, W. D., Stewart, W., Estrada, M. A., Ijspeert, A. J., and Floreano, D., Elastic-actuation mechanism for repetitive hopping based on power modulation and cyclic trajectory generation. IEEE Transactions on Robotics, 2022, 39, 558-571.
22. Zaitsev, V., Gvirsman, O., Hanan, U. B., Weiss, A., Ayali, A., and Kosa, G., A locust-inspired miniature jumping robot. Bioinspiration & biomimetics, 2015, 10, 066012.
23. Zhao, J., Xu, J., Gao, B., et al., MSU jumper: A single-motor-actuated miniature steerable jumping robot. IEEE Transactions on Robotics, 2013, 29, 602-614.
24. Kovac, M., Schlegel, M., Zufferey, J.-C., and Floreano, D., Steerable miniature jumping robot. Autonomous Robots, 2010, 28, 295-306.
25. Jung, G.-P., Casarez, C. S., Jung, S.-P., Fearing, R. S., and Cho, K.-J., An integrated jumping-crawling robot using height-adjustable jumping module. In 2016 IEEE international conference on robotics and automation (ICRA) IEEE, 2016, pp. 4680-4685.
26. Noh, M., Kim, S.-W., An, S., Koh, J.-S., and Cho, K.-J., Flea-inspired catapult mechanism for miniature jumping robots. IEEE transactions on robotics, 2012, 28, 1007-1018.
27. Burdick, J. and Fiorini, P., Minimalist jumping robots for celestial exploration. The International Journal of Robotics Research, 2003, 22, 653-674.
28. Desbiens, A. L., Pope, M. T., Christensen, D. L., Hawkes, E. W., and Cutkosky, M. R., Design principles for efficient, repeated jumpgliding. Bioinspiration & biomimetics, 2014, 9, 025009.
29. Li, F., Liu, W., Fu, X., et al., Jumping like an insect: Design and dynamic optimization of a jumping mini robot based on bio-mimetic inspiration. Mechatronics, 2012, 22, 167-176.
30. Kenneally, G., De, A., and Koditschek, D. E., Design principles for a family of direct-drive legged robots. IEEE Robotics and Automation Letters, 2016, 1, 900-907.
31. Haldane, D. W., Plecnik, M. M., Yim, J. K., and Fearing, R. S., Robotic vertical jumping agility via series-elastic power modulation. Science Robotics, 2016, 1, eaag2048.
32. Haldane, D. W., Yim, J. K., and Fearing, R. S., Repetitive extreme-acceleration (14-g) spatial jumping with salto-1P. In 2017 IEEE/RSJ international conference on intelligent robots and systems (IROS) IEEE, 2017, pp. 3345-3351.
33. Yim, J. K., Singh, B. R. P., Wang, E. K., Featherstone, R., and Fearing, R. S., Precision robotic leaping and landing using stance-phase balance. IEEE Robotics and Automation Letters, 2020, 5, 3422-3429.
34. De, A. and Koditschek, D. E., Parallel composition of templates for tail-energized planar hopping. In 2015 IEEE international conference on robotics and automation (ICRA) IEEE, 2015, pp. 4562-4569.
35. Yim, J. K., Wang, E. K., and Fearing, R. S., Drift-free roll and pitch estimation for high-acceleration hopping. In 2019 international conference on robotics and automation (ICRA) IEEE, 2019, pp. 8986-8992.
36. Klemm, V., Morra, A., Salzmann, C., et al., Ascento: A two-wheeled jumping robot. In 2019 international conference on robotics and automation (ICRA) IEEE, 2019, pp. 7515-7521.
37. Johnson, A. M. and Koditschek, D. E., Toward a vocabulary of legged leaping. In 2013 IEEE international conference on robotics and automation IEEE, 2013, pp. 2568-2575.
38. Brill, A. L., De, A., Johnson, A. M., and Koditschek, D. E., Tail-assisted rigid and compliant legged leaping. In 2015 IEEE/RSJ international conference on intelligent robots and systems (IROS) IEEE, 2015, pp. 6304-6311.
39. Haynes, G. C., Pusey, J., Knopf, R., Johnson, A. M., and Koditschek, D. E., Laboratory on legs: An architecture for adjustable morphology with legged robots. In Unmanned systems technology XIV SPIE, 2012, pp. 349-362.
40. Vidyasagar, A., Zufferey, J.-C., Floreano, D., and Kovac, M., Performance analysis of jump-gliding locomotion for miniature robotics. Bioinspiration & biomimetics, 2015, 10, 025006.
41. Wei, D., Gao, T., Li, Z., Mo, X., Zheng, S., and Zhou, C., Hybrid inspired research on the flying-jumping locomotion of locusts using robot counterpart. Frontiers in neurorobotics, 2019, 13, 87.
42. Baek, S.-M., Yim, S., Chae, S.-H., Lee, D.-Y., and Cho, K.-J., Ladybird beetle-inspired compliant origami. Science Robotics, 2020, 5, eaaz6262.
43. Zhu, B., Xu, J., Charway, A., and Saldana, D., PogoDrone: Design, model, and control of a jumping quadrotor. In 2022 International Conference on Robotics and Automation (ICRA) IEEE, 2022, pp. 2031-2037
44. Boria, F. J., Bachmann, R. J., Ifju, P. G., et al., A sensor platform capable of aerial and terrestrial locomotion. In 2005 IEEE/RSJ international conference on intelligent robots and systems IEEE, 2005, pp. 3959-3964.
45. Kalantari, A. and Spenko, M., Modeling and performance assessment of the HyTAQ, a hybrid terrestrial/aerial quadrotor. IEEE Transactions on Robotics, 2014, 30, 1278-1285.
46. Page, J. R. and Pounds, P. E., The quadroller: Modeling of a UAV/UGV hybrid quadrotor. In 2014 IEEE/RSJ international conference on intelligent robots and systems IEEE, 2014, pp. 4834-4841.
47. Jia, H., Bai, S., Ding, R., et al., A quadrotor with a passively reconfigurable airframe for hybrid terrestrial locomotion. IEEE/ASME Transactions on Mechatronics, 2022, 27, 4741-4751.
48. Zhang, R., Wu, Y., Zhang, L., Xu, C., and Gao, F., Autonomous and adaptive navigation for terrestrial-aerial bimodal vehicles. IEEE Robotics and Automation Letters, 2022, 7, 3008-3015.
49. Fabris, A., Aucone, E., and Mintchev, S., Crash 2 squash: An autonomous drone for the traversal of narrow passageways. Advanced Intelligent Systems, 2022, 4, 2200113.
50. Jia, H., Ding, R., Dong, K., Bai, S., and Chirarattananon, P., Quadrolltor: A reconfigurable quadrotor with controlled rolling and turning. IEEE Robotics and Automation Letters, 2023 8, 4052-4059.
51. Daler, L., Lecoeur, J., Hahlen, P. B., and Floreano, D., A flying robot with adaptive morphology for multi-modal locomotion. In 2013 IEEE/RSJ international conference on intelligent robots and systems IEEE, 2013, pp. 1361-1366.
52. Daler, L., Mintchev, S., Stefanini, C., and Floreano, D., A bioinspired multi-modal flying and walking robot. Bioinspiration & biomimetics, 2015, 10, 016005.
53. Kim, K., Spieler, P., Lupu, E.-S., Ramezani, A., and Chung, S.-J., A bipedal walking robot that can fly, slackline, and skateboard. Science Robotics, 2021, 6, eabf8136.
54. Anzai, T., Kojio, Y., Makabe, T., Okada, K., and Inaba, M., Design and development of a flying humanoid robot platform with bi-copter flight unit. In 2020IEEE—RAS 20th international conference on humanoid robots (humanoids) IEEE, 2021, pp. 69-75.
55. Mellinger, D., Michael, N., and Kumar, V., Trajectory generation and control for precise aggressive maneuvers with quadrotors. The International Journal of Robotics Research, 2012, 31, 664-674.
56. Faessler, M., Franchi, A., and Scaramuzza, D., Differential flatness of quadrotor dynamics subject to rotor drag for accurate tracking of high-speed trajectories. IEEE Robotics and Automation Letters, 2017, 3, 620-626.
57. Sun, S., Romero, A., Foehn, P., Kaufmann, E., and Scaramuzza, D., A comparative study of nonlinear mpc and differential-flatness-based control for quadrotor agile flight. IEEE Transactions on Robotics, 2022, 38, 3357-3373.
58. Wu, A. and Geyer, H., The 3-d spring-mass model reveals a time-based deadbeat control for highly robust running and steering in uncertain environments. IEEE Transactions on Robotics, 2013, 29, 1114-1124.
59. Saranli, U., Arslan, Ö., Ankarah, M. M., and Morgül, Ö., Approximate analytic solutions to non-symmetric stance trajectories of the passive spring-loaded inverted pendulum with damping. Nonlinear Dynamics, 2010, 62, 729-742.
60. Ankarah, M. M. and Saranli, U., Control of underactuated planar pronking through an embedded spring-mass hopper template. Autonomous Robots, 2011, 30, 217-231.
61. Sayyad, A., Seth, B., and Seshu, P., Single-legged hopping robotics researcha review. Robotica, 2007, 25, 587-613.
62. Bai, S. and Chirarattananon, P., SplitFlyer air: A modular quadcopter that disassembles into two bicopters mid-air. IEEE/ASME Transactions on Mechatronics, 2022, 27, 4729-4740.
63. Seipel, J. E. and Holmes, P., Running in three dimensions: Analysis of a point-mass sprung-leg model. The International Journal of Robotics Research, 2005, 24, 657-674.
64. Batts, Z., Kim, J., and Yamane, K., Untethered one-legged hopping in 3d using linear elastic actuator in parallel (leap). In 2016 international symposium on experimental robotics Springer, 2017, pp. 103-112.
65. Raibert, M. H., Brown Jr, H. B., and Chepponis, M., Experiments in balance with a 3D one-legged hopping machine. The International Journal of Robotics Research, 1984, 3, 75-92.
66. Terry, P., Piovan, G., and Byl, K., Towards precise control of hoppers: Using high order partial feedback linearization to control the hopping robot FRANK. In 2016 IEEE 55th conference on decision and control (CDC) IEEE, 2016, pp. 6669-6675.
67. Foehn, P., Romero, A., and Scaramuzza, D., Time-optimal planning for quadrotor waypoint flight. Science Robotics, 2021, 6, eabh1221.
68. Hong, C., Tang, D., Quan, Q., Cao, Z., and Deng, Z., A combined series-elastic actuator & parallel-elastic leg no-latch bio-inspired jumping robot. Mechanism and Machine Theory, 2020, 149, 103814.
69. Shi, J. et al., Good features to track. In 1994 proceedings of IEEE conference on computer vision and pattern recognition IEEE, 1994, pp. 593-600.

1. A robot, comprising:
an aerial unit;
a passive leg mechanism operably coupled with the aerial unit; and
a controller configured to control operation of the aerial unit such that the robot is operable in, at least, a flight mode and a hopping mode.

2. The robot of claim 1, wherein the controller is configured to control operation of the aerial unit such that the robot alternates between the flight mode and the hopping mode during operation.

3. The robot of claim 1, wherein the passive leg mechanism consists only of a single telescopic leg arrangement.

4. The robot of claim 3, wherein the single telescopic leg arrangement comprises:
an upper leg section fixed to the aerial unit;
a lower leg section movably connected with the upper leg section via one or more connectors; and
an elastic mechanism operably coupled between the upper leg section and the lower leg section.

5. The robot of claim 1, wherein the controller is configured to predict a landing location of the robot in the hopping mode.

6. The robot of claim 1, wherein the controller is configured to determine a landing location of the robot for a next hopping cycle based on a landing attitude of the robot for a current hopping cycle.

7. The robot of claim 1, wherein the aerial unit comprises a mini unmanned aerial vehicle or a micro unmanned aerial vehicle.

8. The robot of claim 7, wherein the aerial unit comprises a micro quadcopter.

9. The robot of claim 4, wherein the telescopic leg arrangement further comprises one or more guide wheel sets, each of the one or more guide wheel sets being operably coupled between a respective one of the one or more connectors and the lower leg section to restrict motion of the lower leg section to translation only and to reduce friction.

10. The robot of claim 4, wherein the lower leg section comprises a foot for contacting ground or environment.

11. The robot of claim 10,
wherein the lower leg section comprises a first hook for supporting part of the elastic mechanism; and
wherein at least one of the connectors comprises a second hook for supporting another part of the elastic mechanism.

12. The robot of claim 4, wherein the elastic mechanism comprises one or more elastic elements.

13. The robot of claim 12, wherein the one or more elastic elements are mounted between the upper leg section and the lower leg section such that the one or more elastic elements are tensioned to provide an elastic force operable to overpower weight of the robot.

14. The robot of claim 4, wherein a length measured from a lowest end of the lower leg section to a center of mass (CoM) of the robot is at least twice the length of a wheelbase of the aerial unit.

15. The robot of claim 1, further comprising a stabilizer operable to interact with airflow to stabilize the robot.

16. The robot of claim 15, wherein the stabilizer is configured to control a landing attitude and to stabilize hopping speed and attitude without external feedback or vision.

17. The robot of claim 15, wherein the stabilizer comprises one or more horizontally hinged surfaces.

18. The robot of claim 17, wherein the one or more horizontally hinged surfaces are actuated by a cable arrangement connected to a drive unit.

19. The robot of claim 18, wherein the one or more horizontally hinged surfaces are arranged to be made rigid when the cable arrangement is actuated and swing freely in response to airflow when the cable arrangement is de-actuated.

20. The robot of claim 1, wherein the controller is configured to:
predict a landing location and velocity of the robot for a current hopping cycle (k);
determine a takeoff attitude and a takeoff velocity of the robot for the current hopping cycle (k) based on: the predicted landing location and velocity for the current hopping cycle (k), a pre-specified landing location, and a hopping altitude setpoint for a next hopping cycle (k+1);
determine a desired landing attitude for the current hopping cycle (k) to realize the determined takeoff attitude and takeoff velocity of the robot for the current hopping cycle (k); and
control a landing location for the next hopping cycle (k+1) and stabilize the robot by regulating the landing attitude of the current hopping cycle (k).

21. The robot of claim 20, wherein the controller is configured to:
determine the landing location for the next hopping cycle (k+1) based on: a lateral component of the takeoff velocity and an amount of time the robot spends in an aerial phase, and the takeoff velocity is influenced by the landing attitude.
